(19) United States
(12) Patent Application Publication
(10) Pub. No.: US 2012/0052250 A1
(43) Pub. Date: Mar. 1, 2012

(54) Flexible Microfluidic Device with Interconnected Porous Network

(76) Inventors: Michael Edward DeRosa, Painted Post, NY (US); Po Ki Yuen, Painted Post, NY (US)

(21) Appl. No.: 13/217,912

(22) Filed: Aug. 25, 2011

Related U.S. Application Data
(60) Provisional application No. 61/377,549, filed on Aug. 27, 2010.

(51) Int. Cl. B32B 3/30; B44C 1/22

(52) U.S. Cl. 428/172; 216/11

(57) ABSTRACT

Polymeric sheets having interconnected microporous networks are generated by contacting the sheets with a composition including solvent and non-solvent in an appropriate ratio and removing the composition from the sheet. Such sheets may be advantageously used in micro fluidic devices for a variety of purposes.

### CROSS-REFERENCE

This application claims the benefit of priority under 35 U.S.C. §119 of U.S. Provisional Application Ser. No. 61/377,549 filed on Aug. 27, 2010 the content of which is relied upon and incorporated herein by reference in its entirety.

### FIELD

The present disclosure relates to polymeric sheets having interconnected microporous networks and to microfluidic devices including such sheets.

### BACKGROUND

Microfluidics is emerging as one of the fastest growing fields for chemical and biological applications, and a good deal of effort has been expended in identifying suitable materials and novel functional attributes for use in microfluidic devices. One attractive feature that can be incorporated into micro fluidic devices is a porous membrane or porous regions or materials within or between microfluidic channels. Such porous regions may allow for selective diffusion of gases or other chemical species from one microfluidic channel to another and can have a variety of potential uses, including multiphase catalytic reactions in chemical and pharmaceutical applications. Because of the wide variety of uses and the rapidly growing field, demand has increased for methods of rapidly fabricating low-cost microfluidic devices.

### BRIEF SUMMARY

The present disclosure describes, among other things, easy to manufacture, flexible microfluidic devices that have regions with an interconnected microporous structure. In part, this disclosure is based on the finding that polymeric sheets, or portions thereof, can be rendered microporous by contacting sheets, or a portion thereof, with a solvent composition having a suitable solubility strength for the polymer. In embodiments, the solvent composition comprises a mixture of a solvent and a non-solvent for the polymer. The ratio of solvent to non-solvent is carefully controlled to obtain the desired interconnected porous structure. Such microporous sheets may be used in the manufacture of micro fluidic devices.

In various embodiments described herein, a method for fabricating polymeric sheet having first and second channels separated by a sidewall having an interconnected porous network. The method includes applying one or more masks to a surface of a polymeric sheet to produce a masked polymeric sheet. At least a portion of the one or more masks has a shape generally corresponding to the first and second channels. The method further includes contacting the masked polymeric sheet with a composition comprising a solvent to form the interconnected porous network from the unmasked portions of the polymeric sheet such that the interconnected porous network is raised relative to the masked surface of the polymeric sheet. The composition comprising the solvent has a Hansen relative energy difference from the polymer of between 0.5 and 2 (e.g., 0.75-1.6, 0.8-1.5, or 0.85-1.45). The composition may further comprise a non-solvent, where the ratio of the solvent and non-solvent in the composition is between 30/70 and 99.9/0.01 by volume. The method further includes removing the composition from the masked polymeric sheet and removing the one or more masks from the masked polymeric sheet to expose the first and second channels. The raised interconnected porous network between the first and second channels forms the sidewall separating the channels. In some embodiments, the polymeric sheet is a polystyrene sheet, the solvent is acetone, tetrahydrofuran or ethyl acetate, and the non-solvent is water, isopropanol or ethanol.

In various embodiments described herein, a method for fabricating a microfluidic device having first and second fluid conduits includes (i) providing the polymeric sheet having first and second channels separated by a sidewall having an interconnected porous network, and (ii) applying a film to the polymeric sheet to form the microfluidic device. The first conduit of the device is formed by at least a portion of the film and the first channel of the polymeric sheet. The second conduit of the device is formed by at least a portion of the film and the second channel of the polymeric sheet.

In various embodiments described herein, a method for fabricating a polystyrene sheet having an interconnected porous network includes contacting at least a portion of the polystyrene sheet with a composition comprising a solvent. The composition has a Hansen relative energy difference from the polymer of between 0.5 and 2 (e.g., 0.75-1.6, 0.8-1.5, or 0.85-1.45). The composition may further comprise a non-solvent, wherein the solvent is tetrahydrofuran or ethyl acetate, and the non-solvent is an alcohol selected from isopropanol and ethanol. The ratio of tetrahydrofuran (THF) to alcohol is between 30/70 and 45/55 by volume (if THF is the solvent), or the ratio of ethyl acetate to alcohol is between 45/55 and 65/35 by volume (if ethyl acetate is the solvent).

In various embodiments described herein, a method for fabricating a microfluidic device includes (i) providing a polystyrene sheet having an interconnected porous network; and (ii) applying a patterned double-sided adhesive sheet to the polystyrene sheet. The adhesive sheet is patterned to include a first opening configured to form at least a portion of a first fluid conduit of the microfluidic device. The method further includes applying a film to the other side of the adhesive sheet.

In various embodiments described herein, a method for fabricating a microfluidic device includes providing a polystyrene sheet having an interconnected porous network. The polystyrene sheet includes a channel formed by masking the sheet prior to contacting with the composition comprising solvent and non-solvent. The method further includes applying a film to polystyrene sheet to cover the channel and form a fluid conduit.

In various embodiments described herein, a microfluidic device includes (i) a polymeric sheet having first and second channels separated by a sidewall having an interconnected porous network; (ii) a film; and (iii) a patterned double-sided adhesive sheet disposed between the film and the polymeric sheet. The patterned double-sided adhesive sheet has openings or channels with widths, lengths, and shapes substantially the same as the first and second channels of the polymeric sheet. The openings or channels of the patterned double-sided adhesive sheet are aligned with the first and second channels of the polymeric sheet.

The devices, articles and methods described herein may provide one or more advantages over prior polymeric sheets, micro fluidic devices or methods of manufacturing sheets and devices. For example, embodiments of the methods described herein allow for simple, quick and inexpensive fabrication of microfluidic devices in a regular laboratory setting without expensive equipment. Generation of patterned interconnected microporous networks from polymeric sheets can also be quickly and inexpensively produced using the methods described herein. Due to the simple nature of the process, the sheets can be of nearly any size. Further, the nature of the interconnected porous network can be readily tuned by controlling process conditions or readily available post-processing treatments. Embodiments of microfluidic devices having 3D interconnected microporous channel side walls allow gas diffusion and liquid perfusion can also be accomplished by masking technique with selective oxygen plasma treatment to the microporous channel side walls. Thus, in some embodiments, the same device design can be used for both gas and liquid applications such as multiphase reactions and dynamic cell culture applications. These and other advantages of the various embodiments of the devices and methods described herein will be readily apparent to those of skill in the art upon reading the disclosure presented herein.

### BRIEF DESCRIPTION OF THE DRAWINGS

FIGS. 1-2 are flow diagrams of embodiments of methods for generating an interconnected microporous network from a polymeric sheet.

FIG. 3 is a schematic, diagrammatic depiction of an embodiment of a method for generating an interconnected microporous network from a polymeric sheet.

FIG. 4 is a schematic cross-sectional view of an embodiment of a polymeric sheet having a patterned interconnected microporous network.

FIGS. 5-6 are flow diagrams of embodiments of methods for enhancing the hydrophilicity of an interconnected microporous network of a polymeric sheet.

FIG. 7 is a schematic, diagrammatic depiction of an embodiment of a method for enhancing the hydrophilicity of an interconnected microporous network of a polymeric sheet.

FIGS. 8-9 are schematic exploded views of embodiments of microfluidic devices including a polymeric sheet having an interconnected microporous network.

FIG. 10 is a schematic perspective view of an embodiment of a microfluidic device a polymeric sheet having an interconnected microporous network.

FIG. 11 is a schematic exploded view of an embodiment of a microfluidic device a polymeric sheet having an interconnected microporous network.

FIG. 12 is schematic perspective view of an embodiment of a microfluidic device a polymeric sheet having an interconnected microporous network.

FIGS. 13-16 are schematic cross-sectional views of embodiments of microfluidic devices having a polymeric sheet with an interconnected microporous network.

FIG. 17 is a schematic exploded view of an embodiment of a microfluidic device that includes a polymeric sheet having an interconnected microporous network.

FIG. 18 is schematic cross-sectional view of an embodiment of the microfluidic device depicted in FIG. 17.

FIGS. 19-20 are flow diagrams of embodiments of methods for fabricating microfluidic devices that include a polymeric sheet with an interconnected microporous network.

FIGS. 21A-D are time lapse images of a red and blue food colored dyes wicking experiment.

FIG. 22A-B are images of polystyrene film having an interconnected microporous network generated with a tetrahydrofuran/isopropanol solvent/non-solvent mixture (40/60 v/v %) for 20 s at room temperature. One half of the patterned polystyrene film was exposed to oxygen plasma at 30 W at 60 s while the other half was protected. The dotted line depicts the boundary between the two sides. (A) A transparent self-adhesive tape was adhered across the oxygen plasma treated and untreated sides and a droplet of red colored food dye was separately pipetted onto the two sides. (B) After 90 days of oxygen plasma treatment, a droplet of distilled white vinegar was separately pipetted onto the treated and untreated sides.

FIGS. 23A-K are images of various stages of fabrication of various microfluidic devices.

FIGS. 24A-D are scanning electron micrographs of a portion of a sheet having an interconnected microporous network. FIGS. 24B and 24D are higher magnification views of the images shown in FIG. 24A and FIG. 24B, respectively. The images in FIGS. 24A-B are top views (zero degree tilt). The images in FIGS. 24C-D are at a 45 degree tilt view.

FIGS. 25A-C are time lapse images of an experiment showing color change of bromophenol blue pH indicator solution after absorption of carbon dioxide gas on a sheet having an interconnected microporous network.

FIGS. 26A-I are time lapse images of a carbon dioxide gas absorption experiment using a microfluidic device having an interconnected microporous network generated with a tetrahydrofuran/isopropanol solvent/non-solvent mixture (40/60 v/v %): (a)-(f) for 20 s and (g)-(i) for 20 s for the bottom microporous structures and for 10 s for the microporouos channel side walls at room temperature. (a) t=0 s. (b) t=25 s. (c) t=48 s. (d) t=0 s. (e) t=35 s. (f) t=1 min 35 s. (g) =0 s. (h) t=13 s. (i) t=30 s.

FIGS. 27A-I are time lapse images of a carbon dioxide gas generation and absorption experiment using a microfluidic device having an interconnected microporous network generated with a tetrahydrofuran/isopropanol solvent/non-solvent mixture (40/60 v/v %): (a)-(f) for 20 s and (g)-(i) for 20 s for the bottom microporous structures and for 10 s for the microporouos channel side walls at room temperature. (a) t=0 min. (b) t=2 min. (c) t=4 min 45 s. (d) t=0 min. (e) t=10 min. (f) t=21 min. (g) t=0 min. (h) t=1 min. (i) t=2 min.

FIGS. 28A-I are time lapse images of a vinegar perfusion experiment using a microfluidic device having an interconnected microporous network generated with a tetrahydrofuran/isopropanol solvent/non-solvent mixture (40/60 v/v %) for 20 s at room temperature. (a) t=0 min. (b) t=5 min. (c) t=10 min 45 s. (d) t=0 min. (e) t=2 min. (f) t=15 min. (g) t=0 min. (h) t=8 min. (i) t=13 min.

The schematic drawings presented herein are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising.” For example, a microfluidic device comprising a sheet having an interconnected microporous structure, a double-sided adhesive layer, and a film may consist of, or consist essentially of, the sheet, the adhesive layer and the film.

“Consisting essentially of”, as it relates to a compositions, articles, systems, apparatuses or methods, means that the compositions, articles, systems, apparatuses or methods include only the recited components or steps of the compositions, articles, systems, apparatuses or methods and, optionally, other components or steps that do not materially affect the basic and novel properties of the compositions, articles, systems, apparatuses or methods.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Devices or systems as described herein may be used in a number of directions and orientations.

As used herein, “interconnected microporous structure” refers to a structure having pores or interstices of an average diametric size of less than 1000 micrometers in which pores or interstices are interconnected such that fluid (e.g., liquid, gas, or vapor) may travel between pores or interstices from one surface of the structure to another surface of the structure. It will be understood that interconnected microporous structures may have some “dead ends” or “no-outlets” or “isolated voids.”

As used herein, “pore” means a cavity or void in a surface, a body, or both a surface and a body of a solid article, where the cavity or void has at least one outer opening at a surface of the article.

As used herein, “interstice” means a cavity or void in a body of a solid polymer not having a direct outer opening at a surface of the article, i.e., not a pore, but may have an indirect outer opening or pathway to an outer surface of the article by way of one or more links or connections to adjacent or neighbor “pores” “interstices,” or a combination thereof.

As used herein, a “solvent” for a polymeric sheet is a composition capable of swelling at least a portion of the polymeric sheet when contacted with the sheet. A “non-solvent” for a polymeric sheet means a composition that does not cause swelling of the polymeric sheet when contacted with the sheet.

The present disclosure describes, among other things, microfluidic devices having an interconnected microporous region. The microporous region may be in communication with one or more fluid conduits of the microfluidic device, allowing for exchange of fluid (e.g., liquid, gas or vapor) between the conduits. This disclosure also describes the generation of an interconnected microporous structure by contacting a polymeric sheet, or portion thereof, with a composition comprising a solvent that has a solubility strength suitable for causing the formation of the microporous structure.

### 1. Formation of Microporous Structure

In various embodiments, an interconnected microporous network is generated from at least a portion of a non-porous polymeric sheet. The interconnected microporous network is generated by contacting the polymeric sheet with a composition comprising a solvent for the polymeric sheet. The composition has a Hansen relative energy difference from the polymer of between 0.5 and 2. The composition may further comprise a non-solvent for the polymeric sheet. The ratio of solvent and non-solvent is may be controlled to allow for formation of the interconnected microporous network.

While not intending to be bound by theory, one possible mechanism for achieving an interconnected microporous network is swelling of the polymeric sheet, or a portion thereof, by the solvent and precipitation of the swelled polymer by the non-solvent to form the microporous structure. Another possible mechanism is that the solubility of the polymeric sheet in the composition comprising the solvent provides for the proper degree of swelling of the sheet and removal of the composition comprising the solvent (e.g., via evaporation) results in precipitation of the swelled polymer to form the interconnected microporous network. Regardless of the mechanism of action, it is believed that this is the first report of formation of an interconnected microporous network from a polymeric sheet using a single composition comprising a solvent.

A composition comprising a solvent may include one or more solvents and one or more non-solvents. As generally understood in the art, different polymeric materials are soluble or swellable in different solvents. Accordingly, the one or more solvents employed will be dependent on the polymeric material of the sheet. Any solvent suitable for solubilizing or swelling a polymer of the sheet may be employed. Such solvents are generally known in the art. For example, suitable solvents for polystyrene include tetrahydrofuran, methylethyl ketone, and ethyl acetate and acetone. For cyclic polyolefins suitable solvents include methylene chloride, and tetrahydrofuran. It will be understood that these are only a few examples of the suitable solvents that may be used for these polymers and that other solvents may readily be used and that other polymers with appropriate solvents may be used in accordance with the teachings herein to generate an interconnected microporous structure.

Any one or more non-solvents may be employed. As with solvents, some non-solvents may be selective to the polymeric sheet for which it is desirable to impart an interconnected microporous region. However, many non-solvents will work with most, if not all, polymers. By way of example, suitable non-solvents for polystyrene include water and an alcohol, such as isopropanol, ethanol, and methanol. For cyclic polyolefins, suitable non-solvents include isopropanol and water. It will be understood that these are only a few examples of the suitable non-solvents that may be used for these polymers and that other non-solvents may readily be used and that other polymers with appropriate non-solvents may be used in accordance with the teachings herein to generate an interconnected microporous structure.

As indicated above, it has been found that the solubility strength of the composition (e.g., ratio of solvent and non-solvent) should be finely controlled to produce a desired interconnected microporous network. It will be understood that the ratio and composition of solvent and non-solvent will vary depending on a number of factors, including the composition of the polymeric sheet and the solubility of the polymeric sheet in the solvent employed.

Without intending to be bound by theory, it is believed that the solubility strength of the composition (e.g., solvent/non-solvent ratio) should be within a range to provide a particular degree of solubility or swellability of the polymeric sheet to impart the desired interconnected porous network. The particular range may vary depending on the material and properties of the sheet. However, some general guidelines may be derived from the work described herein. For example, the ratio of solvent to non-solvent may vary from 20/80 to 99.9/0.1 by volume depending on the nature of the polymeric sheet and the solvent and non-solvent. In some embodiments, the ratio of solvent to non-solvent is between 25/75 and 90/10 by volume, such as 30/70 to 70/30 by volume. For polystyrene sheets, it has been found that a ratio of tetrohydrofuran/isopropanol between 30/70 and 45/55 on a volume/volume basis works well to generate an interconnected microporous network from the sheet. By way of further example, it was found that ethyl acetate/isopropanol ratios of between 45/55 and 65/35 produced a desired interconnected microporous network when contacted with and subsequently removed from a polystyrene sheet. Outside of these ranges, interconnected microporous networks were not formed from the polystyrene sheets.

To the extent that the ranges of ratios of solvent and non-solvent may vary from polymeric sheet to polymeric sheet and from solvent to solvent; a suitable range may be readily identified by those of skill in the art. For example, (i) one may try a variety of ratios of known solvents and non-solvents for a particular polymer to determine whether the ratio is suitable for forming an interconnected porous network, (ii) identify those ratios that are suitable and expand around those ratios to find the boundaries of suitable ranges. Any suitable test or assay may be employed to determine whether the composition comprising solvent and non-solvent is capable of imparting an interconnected microporous network to at least portion of the polymeric sheet may be performed. For example, microscopic examination of sheet after contact and removal of the solvent/non-solvent composition may be used to identify whether suitable porous networks have formed. By way of further example, one may employ a liquid wicking test to determine whether the generated porous network is interconnected. If a liquid is blocked from moving across the surface of the sheet and is capable of moving though the generated porous network, then the generated porous network is interconnected. Any suitable liquid wicking test may be employed. By way of example, such a test may be performed generally as described in EXAMPLE 5.

Alternatively or additionally, a strength of a solvent or solvent mixture that is suitable for inducing pore formation on a polymeric article may be determined using Hansen solubility parameters (see, e.g., Hansen, C. M., Hansen Solubility Parameters a User's Handbook 2nd Ed., CRC Press, Boca Raton, 2007). We have found that solvent or solvent mixtures that have Hansen Relative Energy Difference (RED) values in a range of the polymer solubility boundary have been found to cause microporous formation on molded thermoplastic articles. In particular, fluid compositions comprising one or more solvents, which may also contain one or more non-solvents, that have a RED of between about 0.5 and about 2 may be suitable for forming microporous structures on polymeric articles. Preferably, the fluid composition has a RED of between about 0.75 and about 1.6, such as between about 0.8 and about 1.5 or between about 0.85 and about 1.45.

A more detailed discussion of Hansen solubility parameters and RED is discussed in co-pending U.S. patent application Ser. No. 13/217,818, entitled MICROPOROUS THERMOPLASTIC SHEETS, having attorney docket no. SP11-197, naming Michael DeRosa, Todd Upton and Ying Zhang as inventors, and filed on the same date herewith, which application is hereby incorporated herein by reference in its entirety to the extent that it does not conflict with the disclosure presented herein.

According to Hansen, the total cohesion energy (E) of a liquid is defined by the energy required to convert a liquid to a gas. This can be experimentally measured by the heat of vaporization. Hansen described the total cohesion energy as being comprised of three primary intermolecular forces: atomic dispersion forces (E_{D}), molecular permanent dipole-dipole interactions (E_{P}), and molecular hydrogen bonding interactions (E_{H}). When the cohesion energy is divided by the molar volume (V) the total cohesive energy density of the liquid is given by

E/V=E_{D}/V+E_{P}/V+E_{H}/V. (1)

The solubility parameter (δ) of the liquid is related to the cohesive energy density by

δ=(E/V)^{1/2} (2)

where δ is the Hildebrand solubility parameter. The three Hansen solubility components of a liquid are thus given by

δ²=δ_{D}²+δ_{P}²+δ_{H}². (3)

These three parameters have been tabulated for thousands of solvents and can be used to describe polymer-solvent interactions (see, e.g., Hansen, 2007).

Solubility parameters exist for solid polymers as well as liquid solvents (see, e.g., Hansen, 2007). Polymer-solvent interactions are determined by comparing the Hansen solubility parameters of the polymer to that of a solvent or solvent mixture defined by the term Rₐ as

Rₐ²=4(δ_{D2}−δ_{D1})²+(δ_{P2}−δ_{P1})²+(δ_{H2}−δ_{H1})² (4)

where subscripts 1 and 2 refer to the solvent or solvent mixture and polymer respectively. Rₐ is the distance in three dimensional space between the Hansen solubility parameters of a polymer and that of a solvent. A “good” solvent for a particular polymer has a small value of Rₐ. This means the solubility parameters of the polymer and solvent are closely matched and the solvent will quickly dissolve the polymer. Rₐ will increase as a solvent's Hansen solubility parameters become more dissimilar to that of the polymer.

The solubility of a particular polymer is not technically described by just the three parameters in Equation (3). A good solvent does not have to have parameters that perfectly match that of the polymer. There is a range of solvents that will work to dissolve the polymer. The Hansen solubility parameters of a polymer are defined by δ_{D}, δ_{P}, and δ_{H} which are the coordinates of the center of a solubility sphere which has a radius (Rₒ). Rₒ defines the maximum distance from the center of the sphere that a solvent can be and still dissolve the polymer.

The strength of a solvent for a polymer is determined by comparing Rₐ to Rₒ. A term called the Relative Energy Difference (RED) is given by

RED=Rₐ/Rₒ. (5)

Using RED values is a simple way to evaluate how “good” a solvent will be for a given polymer. Solvents or solvent mixtures that have a RED number much less than 1 will have Hansen solubility parameters close to that of the polymer and will dissolve the polymer quickly and easily. Liquids that have RED numbers much greater than 1 will have Hansen solubility parameters further away from the polymer and will have little or no effect on the polymer. Liquids that have RED numbers close to one will be on the boundary between good and poor solvents. These liquids usually swell the polymer and belong to a class of solvents that typically cause environmental stress cracking and crazing (see, e.g., Hansen, C. M.; Just, L., “Prediction of Environmental Stress Cracking in Plastics with Hansen Solubility Parameters, Ind. Eng. Chem. Res., 40, 21-25, 2001).

It will be understood that the width of suitable RED value ranges for inducing pore formation depend on the amount of residual stress in the polymer article, with higher residual stress resulting in higher RED values. That is, the higher the amount of residual stress, or birefringence, the larger the RED value will be for the upper boundary. Polymeric articles that have lower stress or birefringence will require solvents or solvent mixtures that are closer to the center of the sphere within the shaded region to produce porous surfaces.

It will also be understood that the values of R₀ value of a given polymer may change depending on the amount of residual stress or birefringence of the article. The value obtained for R₀ may also change based on the solvents or non-solvents used to determine the R₀ value. If solvents or combinations of solvents and non-solvents are used that are within the micropore forming range then the value of R₀ may more readily change depending on residual stress or birefringence. However, if solvents or combinations of solvents and non-solvents are used that are not within the micropore forming range, the determined R₀ value may not change with changing residual stress or birefringence values. The depth that the generated interconnected microporous network may extend through the sheet may vary and may be controlled by controlling reaction time, temperature, and the like. For example, the interconnected microporous network may be formed only on the surface of the sheet, having a thickness of about, e.g., 10 micrometers to about 100 micrometers, or may extend through the entire depth of the sheet, depending on the amount of time the sheet is in contact with the solvent/non-solvent mixture, etc. The thickness of the non-porous starting sheet will also affect the extent to which the interconnected microporous network extends through the sheet. Typical thicknesses are 1-10 mils, or more typically 1-5 mils.

The non-porous starting sheet may be contacted with the composition comprising solvent and non-solvent in any suitable manner. For example, the sheet may be submersed into the liquid composition, the composition may be sprayed, pipetted, contact printed, ink jet printed, poured or cast onto the sheet, the composition maybe vaporized and applied to the sheet, and the like. It has been found that dipping the sheet into the liquid composition serves as a convenient and readily accessible method for contacting the sheet with the composition. It has also been found that interconnected microporous structures can readily be generated from the sheets at room temperatures, further adding to the convenience. Of course, the temperature may be varied as desired or practicable to achieve a suitable interconnected microporous network.

The pore size of the resulting microporous structure may vary depending on, among other things, the composition of the polymeric material, the birefringence of the material, the solvent and non-solvent used, and the like. It has been found that the average size of the pores generated can be moderately controlled by the solvent composition employed. Average pore sizes generated using the methods described herein, in some embodiments, can range from between 1 micrometer to 500 micrometers, such as between 10 and 200 micrometers. While the mechanism of pore formation is not entirely understood, using an alcohol (e.g. isopropanol or ethanol) as a nonsolvent tends to favor the formation of smaller average pore sizes, and water as a nonsolvent tends to favor formation of larger pore sizes on polystyrene substrates.

The resulting microporous structure that forms from the polymeric article may be an interconnected open cell structure or a non-interconnected open cell structure. Again, while the mechanism is not entirely understood, we have found that higher degrees of orientation (higher birefringence) tends to favor formation of more highly interconnected porous structures. Microscopic examination of the microporous structure may give an indication as to whether the resulting microporous structure is interconnected or non-interconnected.

The pore forming process may be ended by any suitable mechanism, such as removing the composition comprising the solvent and non-solvent from the sheet. The composition may be removed in any suitable manner, such as removing the sheet from the solvent/non-solvent composition source and drying. Drying may be facilitated by increasing temperature, vacuum stripping, or blowing air or nitrogen, or the like. In embodiments, the article is contacted with a non-solvent composition (e.g., having a Hansen RED for the polymer of about 2.2 or higher) that is miscible with the one or more solvents in the solvent composition to extract the solvent from the article. The non-solvent composition, which may contain extracted solvent composition, may be removed, e.g. by drying.

As described in more detail in co-pending U.S. patent application Ser. No. 13/217,818, entitled MICROPOROUS THERMOPLASTIC SHEETS, having attorney docket no. SP11-197 naming Michael DeRosa, Todd Upton, and Ying Zhang as inventors, and filed on the same date herewith, it has been found that contacting the microporous sheet with a non-solvent composition before a significant evaporation of the solvent composition has occurred results in sheets that are more flat (less curling, wrinkling and distortion) than sheets in which the solvent composition is allowed to significantly evaporation from the microporous sheet. It has also been found that arresting the pore formation process by contact (e.g. immersing) with the non-solvent fluid composition (to extract the solvent composition) allows for more reproducible pores size formation, as opposed to allowing or facilitating evaporation of the solvent composition.

In various embodiments, a polymeric sheet with a patterned interconnected microporous structure is fabricated. To produce the patterned sheet, a mask may be applied to a surface of the sheet prior to contacting the sheet with the composition comprising solvent. Any suitable mask may be used. The mask should prevent the surface of the sheet from being contacted with the solvent/non-solvent composition, e.g., when submersed in the composition. Additionally, the mask should be readily removable from the sheet and should not be soluble in the one or more solvents used. In many embodiments, self adhesive tape or other films may be used as a mask. In some embodiments, it may be desirable to mask one entire surface of the sheet and to pattern mask the opposing surface to produce a desired interconnected microporous network from the polymeric sheet.

One convenient way to form a film mask with a desired pattern is to use a desktop digital cutting device, such as described in, for example, P. K. Yuen and V. N. Goral, “Low-cost rapid prototyping of flexible microfluidic devices using a desktop digital craft cutter”, Lab on a Chip, 2010, 10, 384-387. Of course, any other suitable method may be used to cut or produce a mask to a desired pattern such as using a laser.

When a masked polymeric sheet is contacted with a composition comprising solvent and the composition is removed from the masked polymeric sheet, it has been found that the interconnected porous network formed around the masked area is raised relative to the masked surface of the polymeric sheet. Thus, a channel is formed on the resulting sheet having the patterned interconnected microporous network, with the channel having a width, length and shape substantially the same as the mask.

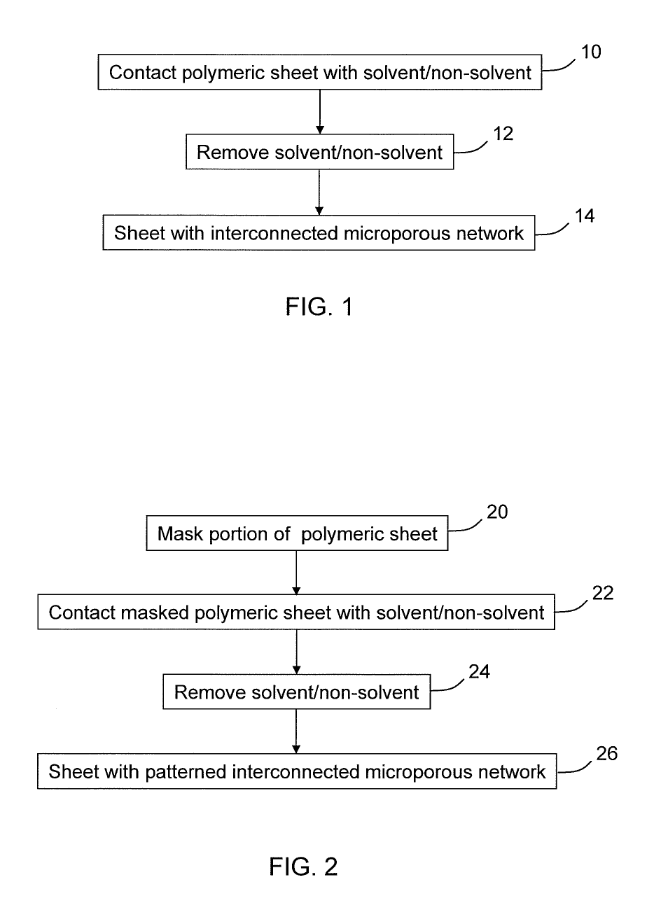

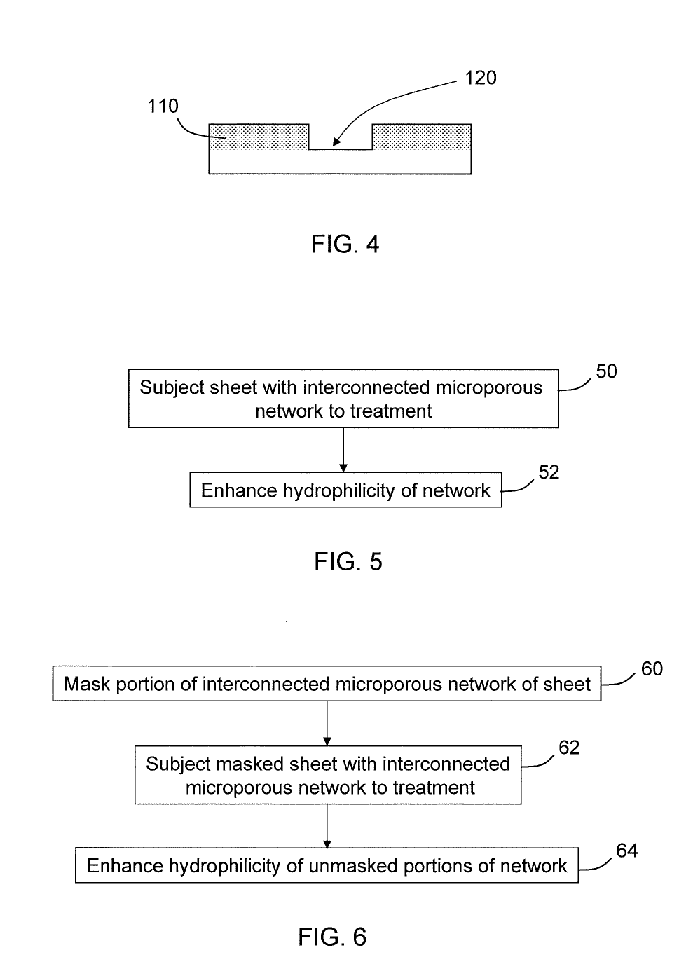

Referring now to FIGS. 1-4, overviews of methods for fabricating sheets having interconnected microporous networks (FIGS. 1-3) and a cross section of a polymeric sheet having an interconnected microporous network (FIG. 4) are shown. As shown in FIG. 1, a polymeric sheet having an interconnected microporous network may be fabricated by contacting a non-porous polymeric sheet with a composition comprising a solvent and a non-solvent (10). The composition comprising the solvent is removed (12) resulting in a polymeric sheet having an interconnected microporous network (14). As indicated above, the composition comprising the solvent may be removed by drying or evaporation or may be effectively removed by dilution or extraction with a non-solvent composition in which the solvent composition is miscible.

FIG. 2 depicts an overview of a method for forming a polymeric sheet with a patterned interconnected microporous network. A portion of a surface of the sheet is masked (20) and the masked sheet is contacted with a composition comprising a solvent and a non-solvent (22). The composition comprising the solvent is removed (24) producing a sheet with the patterned interconnected microporous network (26).

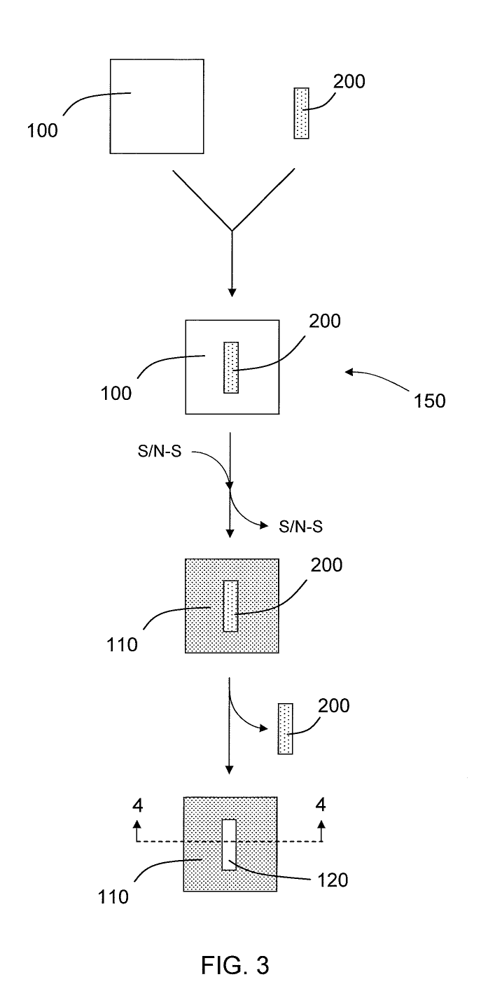

In FIG. 3, a method similar to that described in FIG. 2 is shown in diagrammatic form. First, a mask 200 is placed on a surface of a starting polymeric sheet 100 to produce a masked polymeric sheet 150. The masked polymeric sheet 150 is then contacted with a composition comprising solvent (depicted as solvent and non-solvent: S/N-S), and the composition comprising the solvent (S/N-S) is removed to produce a masked polymeric sheet having an interconnected microporous network 110. The mask 200 is then removed resulting in a polymeric sheet with a portion having interconnected microporous network 110 and portion not having an interconnected microporous network 120. The portion 120 not having the interconnected microporous network corresponds to the portion of the sheet that was masked and retains the surface properties of the starting sheet 100. While not shown, it will be understood that a mask may be placed on the opposite surface of the polymeric sheet to protect the opposite surface from the composition and keep the opposite surface relatively non-porous.

FIG. 4 is a schematic drawing of a cross-section of the sheet having the patterned interconnected microporous structure 110 depicted at the bottom of FIG. 3, taken through line 4-4. As shown in FIG. 4, the portion 120 corresponding to the masked portion that does not have the interconnected porous structure and that retains the properties of the starting polymeric sheet is recessed relative to the portion having the interconnected microporous network 110. Thus, a channel 120 is formed with the sidewalls being a portion of the interconnected microporous network 110.

### 2. Modification of Properties of Microporous Network

Many polymeric sheets are hydrophobic, and rendering regions or surfaces microporous may increases the hydrophobicity of the sheet. Accordingly, aqueous liquids may not readily pass through interconnected microporous networks generated in accordance with the teachings herein. This relative impermeability of aqueous liquids through an interconnected microporous network may be advantageous in some circumstances, some of which will be discussed further below. However, in some situations, it may be desirable for aqueous liquids to pass through the interconnected microporous network.

To improve the ability of aqueous liquids to pass through the interconnected microporous network, the network, or a portion thereof, may be made more hydrophilic. Any suitable method for making a surface or networks more hydrophilic may be employed. For example, plasma treatment, such as oxygen plasma treatment may be employed. Radio frequency (RF) plasma with oxygen gas, corona discharge or microwave plasma may be used. Other methods for increasing hydropilicity or wettability of a surface, such as those described in U.S. Pat. No. 4,413,074, which is incorporated herein by reference in its entirety to the extent that it does not conflict with the present disclosure, may be employed. In U.S. Pat. No. 4,413,074 a hydrophobic polymer surface is contacted with a solution containing hydroxyalkyl cellulose and a perfluorocarbon surfactant in water (or a mixture of water and one or more aliphatic alcohols) to form a layer of the solution on the surface. The surface is then heated to form a bond between the cellulose and the surface, rendering the surface more hydrophilic. Of course, any other methods may be employed to increase the hydrophilicity or wettability of a microporous surface.

With some materials, the effects of treatment to make the material more hydrophilic may not last for long periods of time. Which such materials, it may be desirable to treat the sheet, or portion thereof, close in time to when the sheet is intended to be used. However, different treatments may last for different amounts of time with different materials. For example, it has been found that oxygen plasma treatment of polystyrene sheets having interconnected microporous structures renders the microporous structure hydrophilic and the structure retains its hydrophilicity for extended periods of time—e.g., no apparent change in hydrohilicity 90 days after oxygen plasma treatment. Some of such treatments may render the interconnected microporous structure permanently hydrophilic.

In some embodiments, a hydrophobic sheet having an interconnected microporous sheet is rendered hydrophilic in a patterned manner. To produce such a patterned hydrophilic sheet, a mask may be applied to a surface of the sheet prior to subjecting the sheet to the hydrophilic treatment. Any suitable mask may be used. In many cases, the mask may be a mask as described above with regard to producing a patterned interconnect microporous network. For example, the mask may be formed from self adhesive tape or other film. Regardless of composition of the mask, the mask should prevent the underlying surface of the sheet from being rendered hydrophilic when the sheet is subjected to the hydrophilic treatment. Preferably, the mask is readily removable from the sheet following the treatment.

Referring now to FIGS. 5-7, overviews of methods for enhancing the hydropilicity of at least a portion of a polymeric sheet having an interconnected microporous network are depicted. The method of FIG. 5 includes subjecting the sheet with the interconnected microporous network to a treatment configured to increase the hydrophilicity of the interconnected microporous network (50) to enhance the hydrophilicity of the interconnected microporous network (52).

FIG. 6 depicts and overview of a method for forming a polymeric sheet with an interconnected microporous network in which a portion is rendered more hydrophilic in a patterned manner. A portion of a surface of the sheet is masked (60) and the masked sheet subjected to the treatment (62) to enhance the hydrophilicity of the interconnected microporous network in a patterned manner (64).

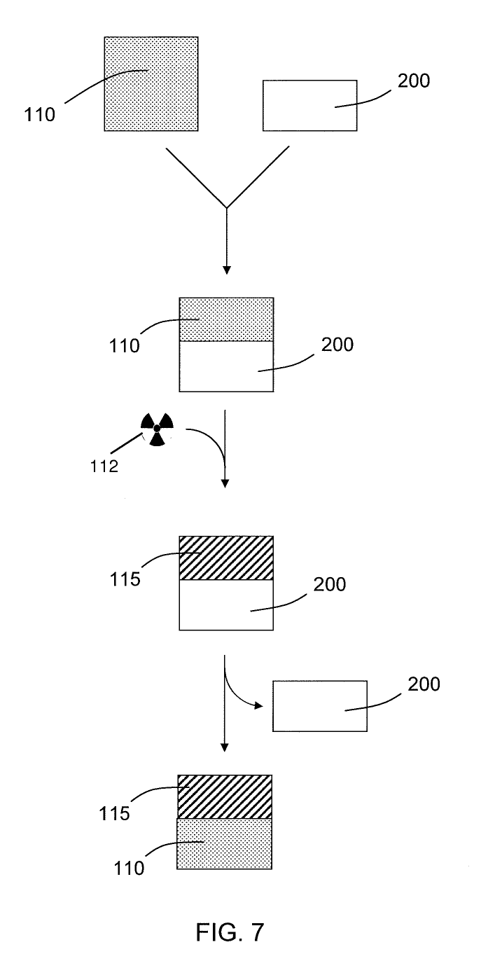

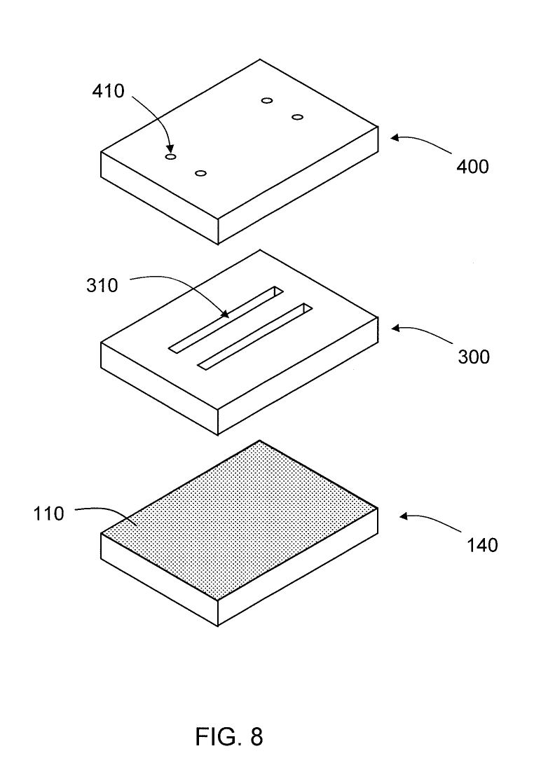

In FIG. 7, a method similar to that described in FIG. 6 is shown in diagrammatic form. First, a mask 200 is placed on a surface of a starting polymeric sheet having an interconnected microporous network 110. The masked polymeric sheet is then subjected to treatment 112, such as oxygen plasma treatment, to render the unmasked portion of the sheet more hydrophilic 115. The mask 200 is then removed resulting in a polymeric sheet with a portion having the initial more hydrophobic interconnected microporous network 110 and portion 115 having a more hydrophilic interconnected microporous network. The portion 110 having the initial more hydrophobic interconnected microporous network corresponds to the portion of the sheet that was masked and retains the surface properties of the starting sheet.

### 3. Formation of Microfluidic Devices

The polymeric sheets having interconnected microporous networks are described above may be used for any application in which such interconnected microporous networks are desired. In many embodiments, the polymeric sheets having interconnected microporous networks are used in microfluidic devices. The interconnected microporous network of the polymeric sheet may serve to allow selective diffusion of liquids, gases or vapors between conduits or chambers of the microfluidic devices, which can be advantageously used for a variety of chemical and biological applications. For example, the microfluidic devices may be used for cell culture with the interconnected microporous network providing for rapid exchange of carbon dioxide and oxygen from and to cells; the microfluidic devices may serve as micro-reactors for multiphasic reactions, such as gas-liquid, liquid-liquid, or gas-liquid-solid reactions; the microfluidic devices may be used for purposes of sample filtration, fluid mixing, valving, lateral flow biological assays; or the like.

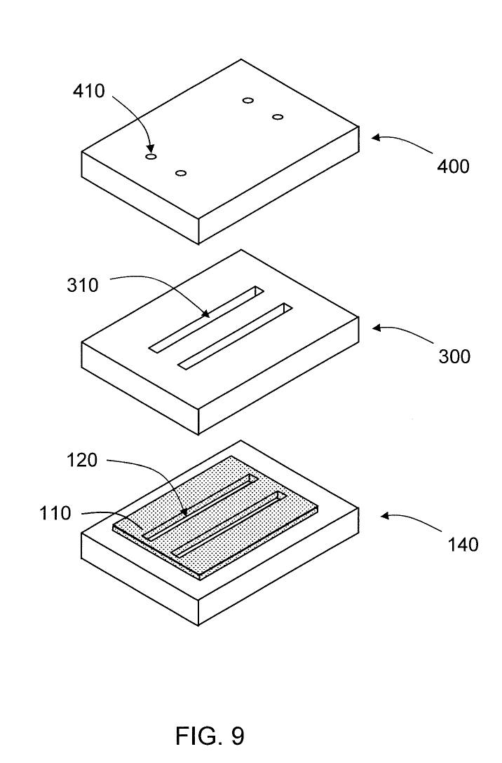

Referring now to FIGS. 8-16 various views of various embodiments of examples of microfluidic devices employing polymeric sheets 140 having interconnected microporous networks produced as described above are shown. FIGS. 8-9 are schematic exploded views of embodiments of microfluidic devices. The devices shown include three layers: a polymeric sheet 140 with an interconnected microporous network 110, a patterned intermediate layer 300 having patterned voids or channels 310 that serve to form at least a portion of a fluid conduit of the assembled device, and a polymeric film 400. It will be understood that the microfluidic device may have other layers or components than those shown.

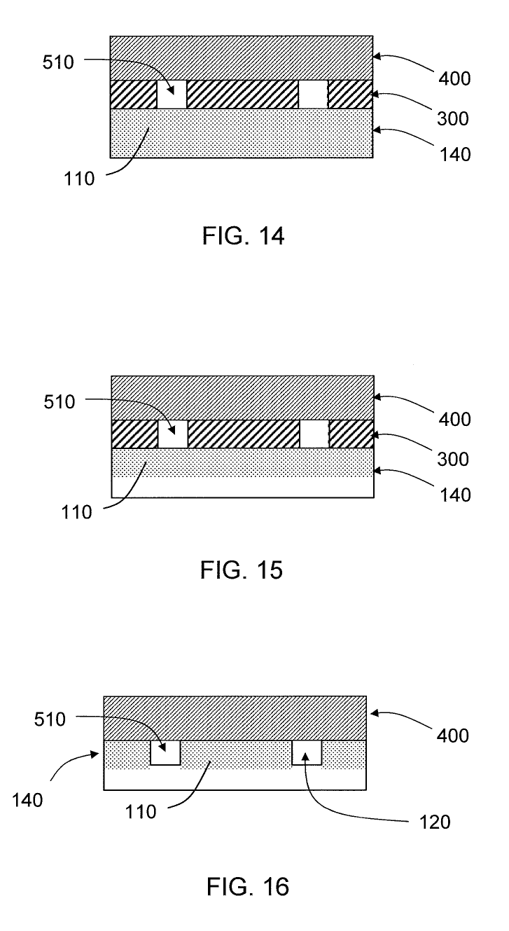

In FIG. 8, the polymeric sheet 140 has an interconnected microporous network 110 that spans an entire surface of the sheet 140. That is, the network is not patterned. The channels 310 of the intermediate layer 300 form the entire sidewall surface of the fluid conduits 510 of the microfluidic device (see, e.g., FIGS. 14-15, which show a schematic cross-section of the device). The polymeric film layer 400 includes openings 410 that are aligned with the channels 310 of the intermediate layer 300 when the device is assembled. The openings 410 may serve as inlets or outlets to the conduits of the device formed in part by the channels 310 of the intermediate layer. As shown in FIGS. 14-15, the fluid conduits of the device 510 are also formed by a portion of a surface of the polymeric sheet 140 having the interconnected microporous network 110 and a portion of a surface of the polymeric film 400. The microporous network 110, due to its interconnectivity, fluidly couples the conduits 510. However, depending on the properties of the network 110 (e.g., how hydrophobic or hydrophilic) some fluids will not readily pass through the network 110 from one conduit 510 to another, while other fluids will readily pass.

As further shown in FIGS. 14-15, the extent that the microporous network 110 extends through the depth of the polymeric sheet 140 can vary or be made to vary as desired. In embodiments, where exchange of ambient gasses is desired, it may be advantageous for the microporous network 110 to extend through the entire depth of the sheet 140, as depicted in FIG. 14.

Referring now to FIG. 9 a schematic exploded view of another embodiment of a microfluidic device is shown. As with the device depicted in FIG. 8 and in other figures presented herein, it will be understood that the microfluidic device may include layers or components other than those depicted. The polymeric sheet 140 depicted in FIG. 9 has a patterned interconnected microporous network 110 with the interconnected microporous network 110 being raised relative to those portions of the surface of the sheet 140 that are free of the interconnected microporous network. In the depicted embodiment, the channels 120 are formed in the interconnected microporous network 110. The channels 310 of the intermediate layer 300 are aligned with the channels 120 of the sheet 140 when the device is assembled. The openings 410 in the film 400 are aligned with the channels 310 of the intermediate layer 300 when the device is assembled and may serve as inlets or outlets to fluid conduits 510 of the device (see, FIG. 13, in which a schematic cross section of an embodiment of a microfluidic device is shown).

As shown in FIG. 13, the sidewalls of the conduits 510 of the assembled device are formed from the channels of the microporous network 110 and the channels of the intermediate layer 300, as well as a surface of the polymeric sheet 140 and the film 400. In some embodiments (not shown), it may be desirable to restrict the interconnected microporous network to only those regions between conduits to minimize the distance a liquid or gas travels through the porous network for selective exchange between the conduits.

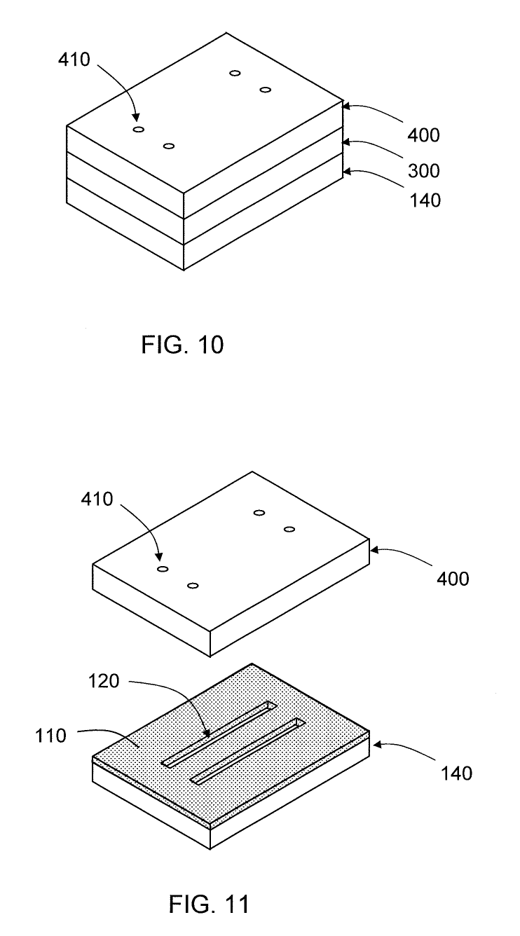

Referring now to FIG. 10, a schematic perspective view of a microfluidic device is shown. The depicted device may represent an assembled device as shown in FIG. 8 or FIG. 9 having three layers: a polymeric sheet 140 having an interconnected microporous network 100, an intermediate layer 300 and a polymeric film 400 having openings 410 serving as inlets or outlets to conduits of the device.

The intermediate layer 300 of the devices depicted in FIGS. 8-10 and FIGS. 13-15 may be formed of any suitable material, such as a polymeric sheet or film. The material used to form the intermediate layer 300 should be compatible with the reagents, cells, or other materials used or assayed with the microfluidic device. The intermediate layer 300 should be secured to the polymeric sheet 140 and polymeric film 400 such that fluid introduced into a conduit of an assembled device does not unintentionally leak. The intermediate layer 300 may be secured to the polymeric sheet 140 or polymeric film in any suitable manner, such as by laser welding, thermal bonding, adhesive, or the like. In many embodiments, the intermediate layer 300 is a double-sided pressure sensitive adhesive layer, which can result in rapid and simple assembly of the microfluidic device.

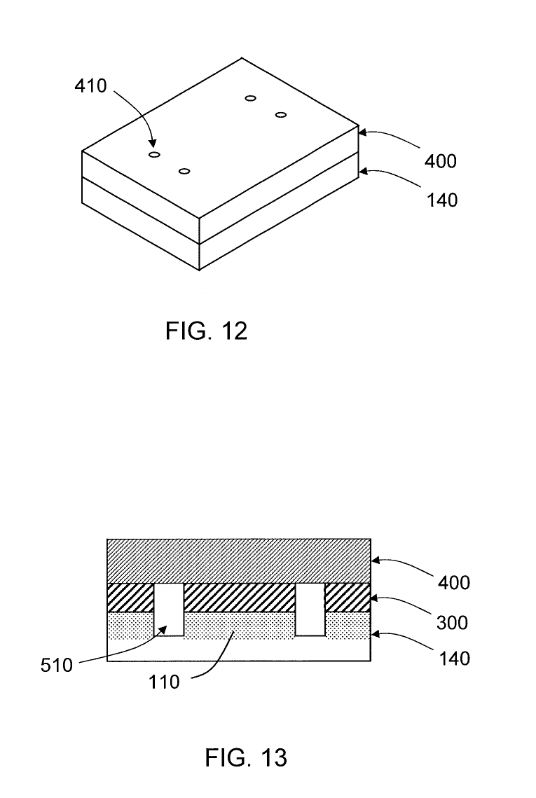

Referring to FIG. 11-12, exploded (FIG. 11) and perspective (FIG. 12) views of embodiments of a microfluidic device having two layers are shown. The device includes a polymeric sheet 140 having an interconnected microporous network 110 and a polymeric film 400. The interconnected microporous network 110 is patterned such that two channels 120 are formed in the network 110. The network 110 forms the sidewalls of the channels. The film 400 may be thermally bonded, laser welded, adhered, or otherwise affixed or secured to the sheet 140. The film 400 has openings 410 that are aligned with the channels 120 of the polymeric sheet 140 when the device is assembled. The channels 120 may serve as fluid conduits of the device with the openings 410 serving as inlets or outlets to the fluid conduits.

FIG. 16 shows a cross section of an embodiment of a device as shown in FIGS. 11-12. The assembled device includes fluid conduits 510 or channels 120, having sidewalls formed from the microporous network 110. A surface of the film 400 serves as the top of the conduits 510, and a surface of the sheet 140 serves as the bottom of the conduits 510.

The polymeric film 400 depicted in FIGS. 8-16 may be made of any suitable material. The polymeric film 400 should be compatible with the reagents, cells, or other materials used or assayed with the microfluidic device. It may be desirable to use a transparent film so that internal portions of the microfluidic device may be seen. Suitable polymeric films include amorphous or mostly amorphous transparent polymer films, such as acrylics, polycarbonates, polystyrenes, or cyclic olefin copolymers. In some embodiments, the film 400 is laser printer transparency film, such as 3M Transparency Film for Laser Printers, Model CG3300, or the like. In some embodiments, the polymeric film 400 is pressure sensitive adhesive tape, such as transparent tape.

While the openings 410 serving as inlets or outlets to the fluid conduits of the assembled devices are shown as being in the polymeric film 400, it will be understood that such openings may also, or alternatively, be created in the polymeric sheet 140.

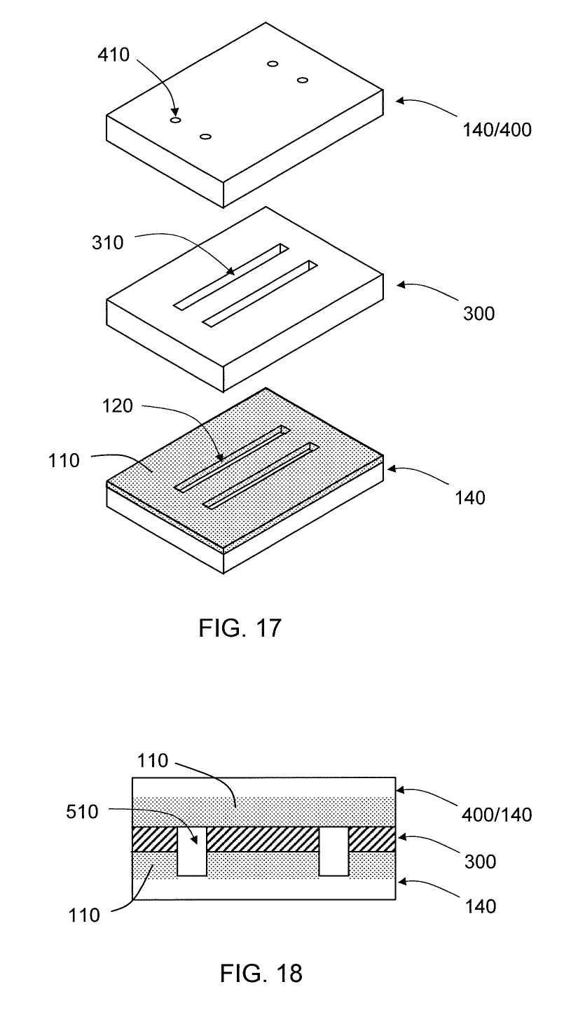

In some embodiments, the polymeric film 400 is formed from the same material as the polymeric sheet 140 and may also be a polymeric sheet having an interconnected polymeric network. For example and referring to FIGS. 17-18, the depicted microfluidic devices include a polymeric film 400 that is a polymeric sheet 140 having a microporous region 110. The device also includes a second polymeric sheet 140 having a microporous region 110 and channels 120. In the depicted embodiments, the device also includes an intermediate layer 300 having channels 310 that align with the channels 120 of the sheet 140 when the device is assembled to form at least a part of the fluid conduits 510 of the device.

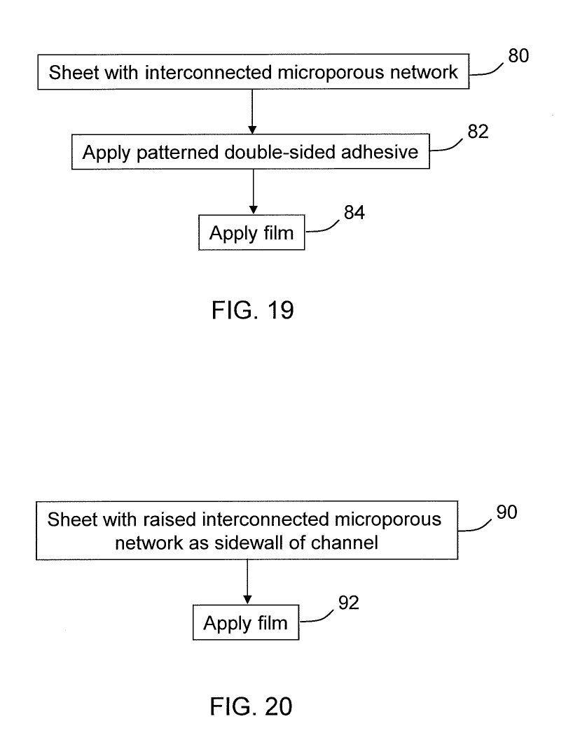

Referring now to FIGS. 19-20 overviews of embodiments for fabricating microfluidic devices are shown. The method depicted in FIG. 19 includes providing a sheet having an interconnected microporous network (80). As used herein, “providing,” as it relates to a method, means to manufacture, purchase, or otherwise obtain. The method further includes applying a patterned double-sided adhesive to the sheet (82) and applying a film to the other side of the double-sided adhesive (84).

The method in FIG. 20 includes providing a sheet having a raised interconnected microporous network as a sidewall of a channel (90) and applying a film to the sheet (92).

While the methods depicted in FIGS. 19-20 are quite general, some more specific examples of fabrication of microfluidic devices that include polymeric sheets having interconnected microporous networks are described below.

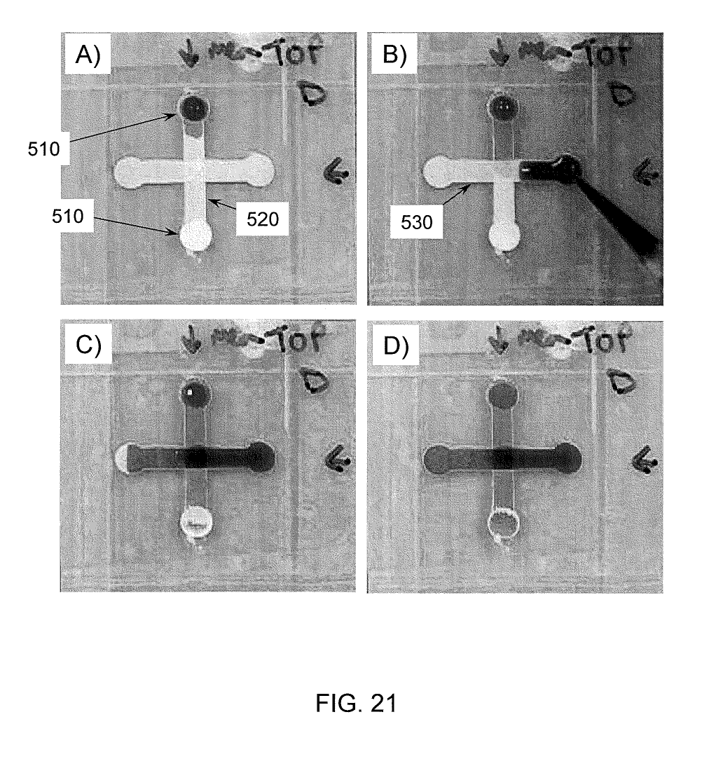

For example, a wicking-based microfluidic device may be fabricated in a very simple, quick and inexpensive process in a regular laboratory setting without expensive equipment and can be accomplished in less than 15 minutes. For example, see FIGS. 21A-D in which images showing fluid wicking on a device fabricated in minutes are shown. The device has circular microporous regions 510 that extend all the way through the film. The device also includes rectangular microporous regions on the bottom side of the film 520 and on the top side of the film 530. Red-dyed water was added to the top circular region (FIG. 21A) and blue-dyed water was added to the right circular region (FIG. 21B). As shown in FIGS. 21C-D, over time the red-dyed water moved through the rectangular microporous region 520 connected to the top circular microporous region 510 and the blue-dyed water moved through the rectangular microporous region 530 connected to the right circular microporous region. As the rectangular microporous regions 520, 530 were not interconnected, the red-dyed and blue-dyed water did not interact.

Such wicking-based microfluidic devices have several advantages over paper based analytical devices, the fabrication of which typically involves complex steps such as photolithography, plotting, inkjet etching, plasma etching, cutting or wax printing. One example for a simple process for fabricating a wicking-based microfluidic device according to the teaching presented herein includes: (i) preparing self-adhesive masks by cutting vinyl self-adhesive sheets using a desktop digital craft cuter; (ii) applying the masks on a polymeric sheet; (iii) placing the masked sheet in a composition having an appropriate ratio of solvent and non-solvent for about 10 seconds to about 2 minutes (iv) removing the sheet from the source of the composition and blow drying with nitrogen gas for about 2 minutes to about 3 minutes; (v) removing the masks; and (vi) oxygen plasma treating the resulting sheet for about 60 seconds. In some cases, the plasma treatment may be performed before removing the mask to render only the microporous structure more hydrophilic. This entire process can be completed in minutes using inexpensive equipment and reagents.

Another example, based on the teachings presented herein, is the fabrication of a flexible microfluidic device with microporous channel side walls. Such a device can be fabricated in a very simple, quick and inexpensive manner in a regular laboratory setting without expensive equipment and can be accomplished in less than an hour. An example method includes: (i) preparing self-adhesive masks by cutting vinyl self-adhesive sheets using a desktop digital craft cuter; (ii) applying the masks on a polymeric sheet; (iii) placing the masked sheet in a composition having an appropriate ratio of solvent and non-solvent for about 10 seconds to about 2 minutes; (iv) removing the sheet from the source of the composition and blow drying with nitrogen gas for about 2 minutes to about 3 minutes; (v) removing the masks; (vi) selectively oxygen plasma treating for liquid perfusion applications; (vii) punching out inlet and outlet holes through the patterned film; (viii) preparing double-sided pressure sensitive adhesive (PSA) tape using a desktop digital craft cutter; and (ix) assembling the microfluidic device by sandwiching pattened double-sided PSA tape between patterned film and laser printer transparency film or between two patterned films.

### 4. Synopsis

This disclosure in various aspects describes methods and devices.

In a first aspect, a method for fabricating a polymeric sheet is described. The polymeric sheet has first and second channels separated by a sidewall having an interconnected porous network. The method comprises (i) applying one or more masks to a surface of a polymeric sheet to produce a masked polymeric sheet, at least a portion of the one or more masks having a shape generally corresponding to the first and second channels; and (ii) contacting the masked polymeric sheet with a composition comprising a solvent and a non-solvent to form the interconnected porous network from the unmasked portions of the polymeric sheet such that the interconnected porous network is raised relative to the masked surface of the polymeric sheet. The composition comprising the solvent has a Hansen relative energy difference from the polymer of between 0.5 and 2 (e.g., 0.75 and 1.6, 0.8 and 1.5, or 0.85 and 1.45). The composition may further comprise a non-solvent for the polymer, wherein the ratio of the solvent and non-solvent in the composition is between 30/70 and 99.9/0.01 by volume. The method further includes (iii) removing the composition from the masked polymeric sheet; and (iv) removing the one or more masks from the masked polymeric sheet to expose the first and second channels, wherein the raised interconnected porous network between the first and second channels forms the sidewall separating the channels.

A second aspect is a method of the first aspect, wherein the polymeric sheet is a polystyrene sheet and wherein the solvent comprises tetrahydrofuran or ethyl acetate and wherein the non-solvent comprises water, isopropanol or ethanol.

A third aspect is a method of the first or second aspect, wherein the solvent comprises tetrahydrofuran and the non-solvent comprises isopropanol or ethanol, and wherein ratio of solvent to non-solvent is between 30/70 and 45/55 by volume.

A fourth aspect is a method of the first, second or third aspect, wherein the solvent comprises ethyl acetate and the non-solvent comprises isopropanol or ethanol, and wherein the ratio of solvent to non-solvent is in the range of 45/55-65/35 by volume.

In a fifth aspect, a method for fabricating a microfluidic device having first and second fluid conduits includes (i) providing the polymeric sheet having first and second channels separated by a sidewall having an interconnected porous network produced according to a method of any of the first, second, third, or fourth aspect; and (ii) applying a film to the polymeric sheet to form the microfluidic device, wherein the first conduit of the device comprises at least a portion of the film and the first channel of the polymeric sheet and wherein the second conduit of the device comprises at least a portion of the film and the second channel of the polymeric sheet.

A sixth aspect is a method of the fifth aspect, wherein the polymeric sheet is a polystyrene sheet and wherein the solvent comprises tetrahydrofuran or ethyl acetate and wherein the non-solvent comprises water, isopropanol or ethanol.

A seventh aspect is a method of the fifth or sixth aspect, wherein the solvent comprises tetrahydrofuran and the non-solvent comprises ispropanol or ethanol, and wherein ratio of solvent to non-solvent is between 30/70 and 45/55 by volume.

An eighth aspect is a method of the fifth, sixth or seventh aspect, wherein the solvent comprises ethyl acetate and the non-solvent comprises isopropanol or ethanol, and wherein the ratio of solvent to non-solvent is in the range of 45/55-65/35 by volume.

A ninth aspect is a method of the fifth, sixth, seventh or eight aspect, wherein the film is adhesive tape.

A tenth aspect is a method of the fifth, sixth, seventh or eight aspect, wherein the film is a polymeric sheet having an interconnected porous network.

An eleventh aspect is a method of the tenth aspect, wherein the film is a polymeric sheet having a patterned interconnected porous network.

A twelfth aspect is a method of the fifth, sixth, seventh, eight, ninth, tenth or eleventh aspect, further comprising (i) creating openings in a double-sided adhesive sheet having widths, lengths and shapes substantially the same as the first and second channels of the polymeric sheet; and (ii) applying the double-sided adhesive sheet to the polymeric sheet such that the openings in the double-sided adhesive sheet are substantially aligned with the first and second channels of the polymeric sheet, wherein applying the film to the polymeric sheet comprises applying the film to the side of the double-sided adhesive that is not adhered to the polymeric sheet.

A thirteenth aspect is a method of any of the fifth through the twelfth aspects, further comprising increasing the hydrophilicity of at least a portion of the interconnected porous network between the first and second channels to allow aqueous fluid to flow between the first and second channels through the porous sidewall.

A fourteenth aspect is a method of the thirteenth aspect, wherein increasing the hydrophilicity of the at least a portion of the interconnected porous network comprises plasma treating at least a portion of the interconnected porous network.

A fifteenth aspect is a method for fabricating a polystyrene sheet having an interconnected porous network. The method comprises contacting at least a portion of the polystyrene sheet with a composition comprising a solvent. The composition comprising the solvent has a Hansen relative energy from the polymer of between 0.5 and 2 (e.g., 0.75-1.6, 0.8-1.5, or 0.85-1.45). The composition may further comprise a non-solvent for the polymer, wherein the solvent is tetrahydrofuran or ethyl acetate and wherein the non-solvent is an alcohol selected from isopropanol and ethanol, wherein the ratio of tetrahydrofuran to alcohol is between 30/70 and 45/55 by volume (if tetrahydrofuran is the solvent), and wherein the ratio of ethyl acetate to alcohol is between 45/55 and 65/35 by volume (if ethyl acetate is the solvent).

A sixteenth aspect is a method for fabricating a microfluidic device. The method comprises (i) providing a polystyrene sheet having an interconnected porous network fabricated according to the method of the fifteenth aspect; (ii) applying a patterned double-sided adhesive sheet to the polystyrene sheet, wherein the adhesive sheet is patterned to include a first opening configured to form at least a portion of a first fluid conduit of the microfluidic device; and (iii) applying a film to the other side of the adhesive sheet. In embodiments, the interconnected porous network will have an inlet and/or an outlet for the channel or conduit.

A seventeenth aspect is a method for fabricating a microfluidic device. The method comprises (i) providing a polystyrene sheet having an interconnected porous network fabricated according to the method of the fifteenth aspect, wherein the polystyrene sheet includes a channel formed by masking the sheet prior to contacting with the composition comprising solvent and non-solvent; and (ii) applying a film to polystyrene sheet to cover the channel and form a fluid conduit.

An eighteenth aspect is a method of the fifteenth, sixteenth or seventeenth aspect, wherein the polystyrene sheet includes a channel formed by masking the sheet prior to contacting with the composition comprising solvent and non-solvent, and wherein applying the patterned double-sided adhesive sheet to the polystyrene sheet comprises aligning the first opening of the adhesive sheet with the channel of the polystyrene sheet.

A nineteenth aspect is a microfluidic device comprising (i) a polymeric sheet having first and second channels separated by a sidewall having an interconnected porous network; (ii) a film; and (iii) a patterned double-sided adhesive sheet disposed between the film and the polymeric sheet, the patterned double-sided adhesive sheet having openings with widths, lengths, and shapes substantially the same as the first and second channels of the polymeric sheet, wherein the openings of the patterned double-sided adhesive sheet are aligned with the first and second channels of the polymeric sheet.

A twentieth aspect is a microfluidic device of the nineteenth aspect, wherein the polymeric sheet is a polystyrene sheet.

In the following, non-limiting examples are presented, which describe various embodiments of the articles and methods discussed above.

### EXAMPLES

### Example 1

### Three-Dimensional (3D) Raised Interconnected Microporous Structure Patterning of Film

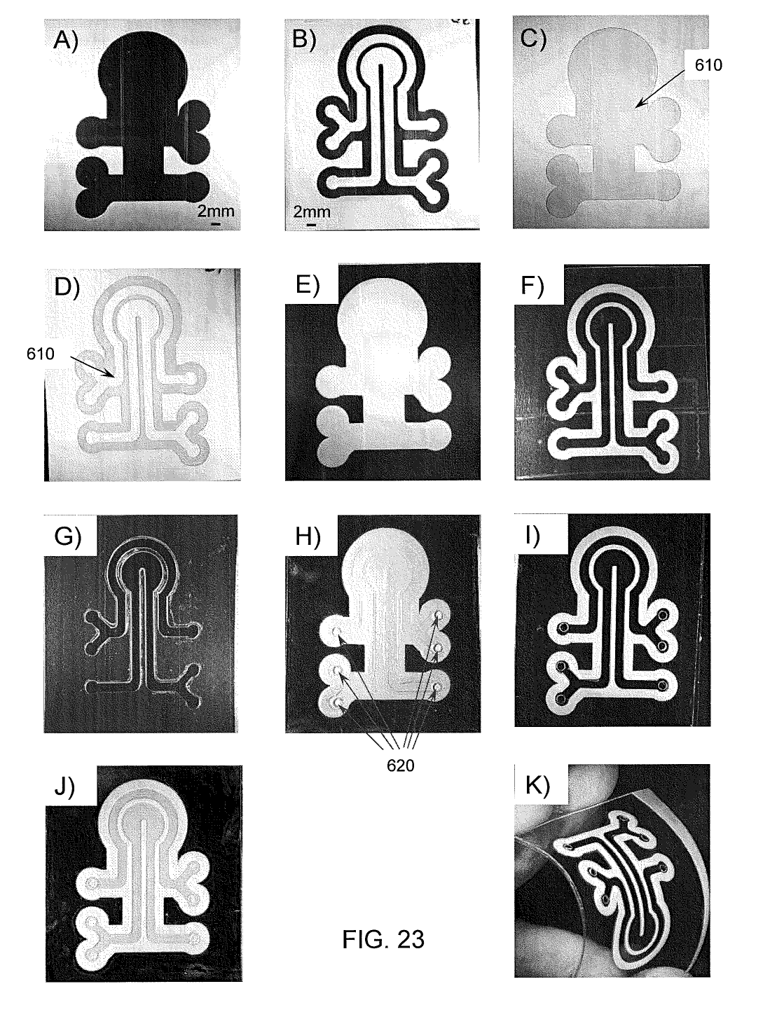

A customized microfluidic device design mask was cut out from a white vinyl self-adhesive sheet (Item # 699009; The Paper Studio®, Oklahoma City, Okla., USA) using a desktop digital craft cutter generally as described in P. K. Yuen and V. N. Goral, Lab on a Chip, 2010, 10, 384-387. The cut vinyl sheet was then adhered to one side of a 3 mil thick polystyrene film (TRYCITE™ 1003U, Dow Chemical Company, Midland, Mich., USA) as a protective mask (FIGS. 23A and 23B). The backside of the polystyrene film was also protected by transparent self-adhesive tapes (6200 ¾″ Highland™ Invisible Tape; 3M, Stationery Products Division, St. Paul, Minn., USA). Of course a second vinyl sheet could alternatively be used to protect the entire backside of the film.

After preparing the sample, the masked polystyrene film was dipped into a mixture of solvent and non-solvent. For polystyrene, the solvents used were tetrahydrofuran (THF), methylethyl ketone, or ethyl acetate. The non-solvents that were employed include water, isopropanol (IPA), ethanol, and methanol (Fisher Scientific, Pittsburgh, Pa., USA). It was found that particular ratios of solvent and non-solvent were useful in forming interconnected microporous structures.

For example, we found that a mixture of THF and IPA or THF and ethanol worked well to form interconnected microporous structures. We also found that ethyl acetate as the solvent and IPA or ethanol as the non-solvent also worked well to form interconnected microporous structures. We were able to produce interconnected microporous structures using a ratio of 30/70-45/55 of THF/IPA or THF/ethanol on a vol/vol % basis, while formation of interconnected microporous structures was not observed with ratios outside this range. For ethyl acetate/IPA, we were able to form interconnected microporous structures using a vol/vol ratio in the range of 45/55-65/35. Outside this range, we did not observe formation of microporous structures.

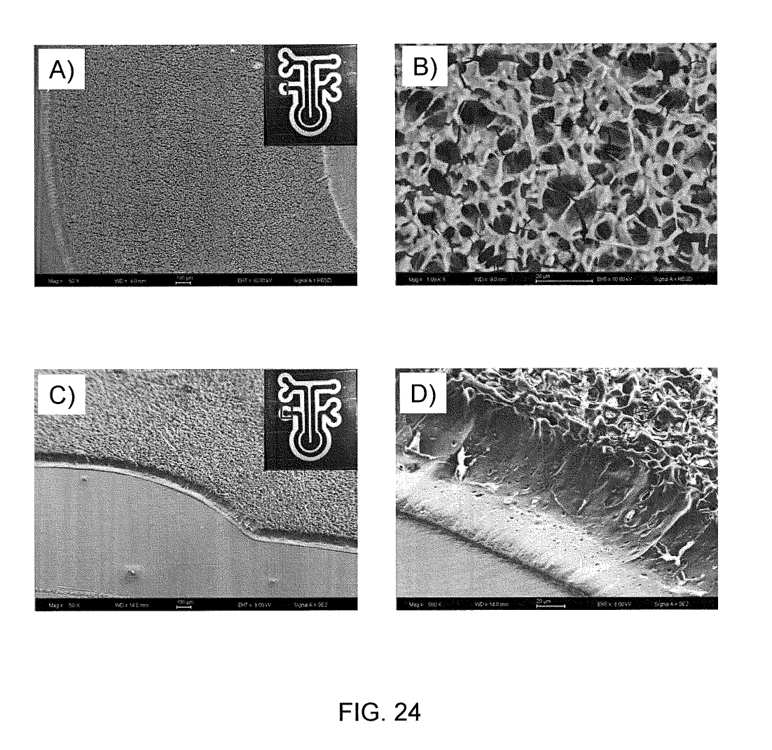

For the remainder of the examples in this disclosure, devices were made using a 40/60 v/v % mixture of THF/IPA. The samples were dipped for 10-40 seconds at room temperature. The film was then removed from the solvent mixture bath and immediately blown dry with nitrogen gas for 2-3 min to ensure that the solvent mixture was completely evaporated (FIGS. 23C and 23D). Finally, the protective masks were removed from the patterned polystyrene film to reveal the 3D raised interconnected microporous structures on the unprotected polystyrene film surfaces (FIGS. 23E and 23F). Scanning electron micrographs of a portion of a sheet similar to that depicted in FIG. 23F are shown in FIGS. 24A-D, revealing the interconnected microporous structure and the raised nature of the microporous structure. The square in the insets of FIGS. 24A and 24C indicate to portion of the overall sheet to which the images correspond. FIGS. 24B and 24D are higher magnification views of the images shown in FIG. 24A and FIG. 24B, respectively. The images in FIGS. 24A-B are top views (zero degree tilt). The images in FIGS. 24C-D are at a 45 degree tilt view, showing the microporous network being raised relative to those portions that were masked.

For applications that make use of aqueous liquid perfusion, the patterned microporous structures were selectively oxygen plasma treated before assembling the final devices.

### Example 2

### Device Designs

Three example embodiments of 2D flexible microfluidic devices with microporous channel walls were developed to demonstrate their ability to perform both gas reactions and liquid perfusion. All three device designs had the same configuration and consisted of a 9.4 mm diameter inner circular chamber and a 2 mm wide outer circular channel separated by a 1 mm wide circular wall. Also, two device designs had a 2 mm wide outer wall to define the shape of the device. In the first device design, the bottom device surface was patterned with interconnected microporous structures, which can be raised above, the same level as or below the non-patterned surface of the patterned polymer film, and double-sided pressure sensitive adhesive (PSA) tape served as the channel/chamber barriers (FIG. 23G) and its thickness as the channel/chamber height (FIG. 23H). Thus, the path of gas diffusion and liquid perfusion was through the interconnected microporous bottom device surface.

In the second device design, all the channel/chamber side walls were patterned with raised interconnected microporous structures (FIG. 23I). In this device design, the channel/chamber side walls consisted of the raised interconnected microporous structures and the double-sided PSA tape. The path of gas diffusion and liquid perfusion was through the raised interconnected microporous channel side walls. The final device design was the combination of the first and second device designs so that gas diffusion and liquid perfusion could occur through both the interconnected microporous bottom surface and the interconnected microporous channel side walls (FIG. 23J).

FIGS. 23A and 23B show images of white vinyl self-adhesive sheets that were cut and adhered to polystyrene film as a protective mask. The back side of the polystyrene sheet was also protected by transparent self-adhesive tape. FIGS. 23C and 23D show the constructs of FIGS. 23A and 23B, respectively, after 20 second dipping in a 40/60 (v/v %) tetrahyrdofuran/isopropanol solvent mixture at room temperature and blown dry in nitrogen gas. FIGS. 23E and 23F show the respective polystyrene films after removal of the masks, revealing raised three dimensional microporous structures. FIG. 23G is an image of a cut double-sided pressure sensitive adhesive tape that was used in the final construction of the device. In FIGS. 23H-K, the fully constructed microfluidic devices are shown, following placement of the cut double-sided adhesive tape (FIG. 23G) on patterned porous polystyrene film (FIG. 23E or 23F) and covered with laser printer transparency film (or unpatterned polystyrene film) or patterned porous polystyrene film (FIG. 23F or 23E). Inlet and outlet holes were punched out either from the patterned polystyrene film (FIG. 23F) or from the laser printer transparency film before device assembly. The device depicted in FIG. 23H utilizes the patterned polystyrene film depicted in FIG. 23E, the cut double-sided adhesive tape depicted in FIG. 23G and a laser printer transparency. The devices depicted in FIGS. 23I and 23K utilize the patterned polystyrene film depicted in FIG. 23F, the cut double-sided adhesive tape depicted in FIG. 23G and a laser printer transparency. The device depicted in FIG. 23J utilizes the polystyrene sheets depicted in FIGS. 23E and 23F, and the cut double-sided adhesive tape depicted in FIG. 23G. The labels 610 in FIGS. 23C and 23D point out the microporous regions. The labels 620 in FIG. 23H indicate the location of holes punched out to form inlets or outlets before device assembly.

### Example 3

### Device Fabrication and Assembly

The fabrication and assembly of the 2D or 3D flexible microfluidic devices were similar to that previously described in Yuen and Goral, supra. Briefly, a customized microfluidic device design was first cut out from a double-sided PSA tape (ARcare® 8890; Applied Research, Inc., Glen Rock, Pa., USA). After inlet and outlet holes were punched through the patterned polymer film (e.g., polystyrene film) or a laser printer transparency film (3M Transparency Film for Laser Printers—CG3300; 3M Visual Systems Division, Austin, Tex., USA), the cut double-sided PSA tape with the top and bottom protective layers removed was manually aligned and sandwiched between the patterned polystyrene film and the laser printer transparency film or another patterned polystyrene film. Thus, 2D flexible microfluidic devices with interconnected microporous channel walls (microporous bottom device surface, microporous channel side walls or both microporous bottom device surface and microporous channel side alls) were fabricated (FIGS. 23H-23K). Three-dimensional flexible microfluidic devices with interconnected microporous channel walls can be fabricated by repeating the above fabrication process. Finally, leak free inlet and outlet connections were attached to the inlet and outlet holes as previously described in Yuen and Goral, supra.

The 3D raised interconnected microporous structures on the patterned polystyrene film were used in the three example embodiments of the 2D flexible microfluidic devices as hydrophobic microporous channel walls: microporous bottom device surface, microporous channel side walls, and both microporous bottom device surface and microporous channel side walls. The example devices were fabricated by using an inexpensive desktop digital craft cutter as an effective, low-cost rapid prototyping method (see, Yuen and Goral, supra).

For microfluidic devices with only raised microporous channel/chamber side walls, a single-sided PSA tape can be used to enclose the channels/chambers instead of using double-sided PSA tape and laser printer transparency film. In this case, the complete fabrication process can be completed in less than 15 minutes. However, the disadvantage of this approach is that the inner top surface of the channels/chambers may be coated with PSA which may not be a desirable surface for certain applications such as cell culture. In addition, there may be a risk of PSA adhering to the inner channel/chamber bottom surface and affecting the performance of the microfluidic devices. Other sealing methods such as thermal or organic solvent assisted bonding can be used to enclose the open microporous channel walls with a thin polymer film (see, e.g., J. de Jong et al., Lab on a Chip, 2005, 5:151-157 and C.-W. Tsao and D. L. DeVoe, Microfluidics and Nanofluidics, 2009, 6:1-16). However, in this case, there may be a risk of destroying the microporous structures and the microporous interconnectivity which will affect the performance of the microfluidic devices.

### Example 4

### Oxygen Plasma Treatment

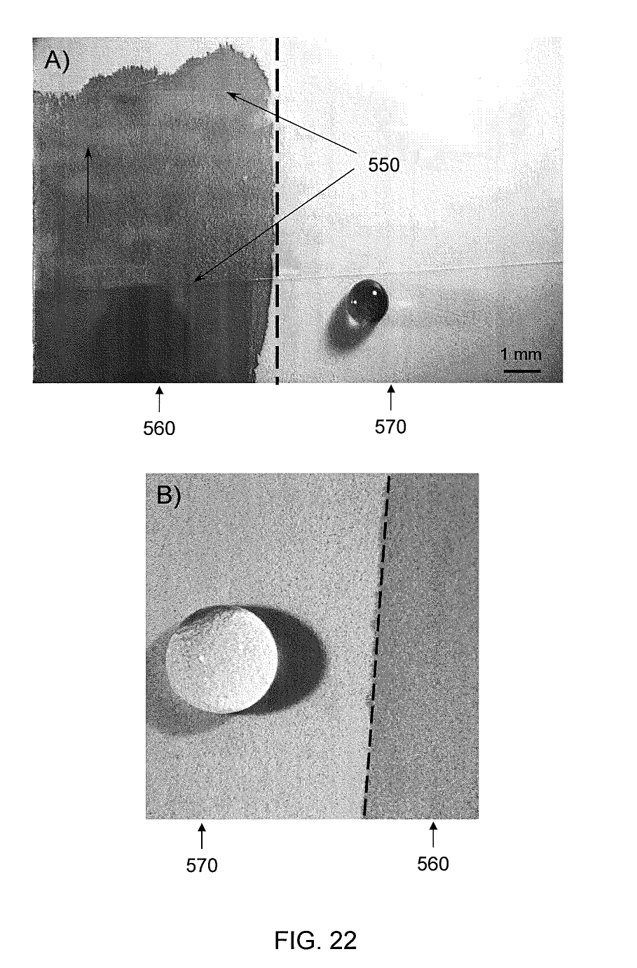

The microporous structures on the patterned polystyrene film were made hydrophilic by treating them with oxygen plasma (FIG. 22). Selected regions of the patterned film were plasma treated by placing transparent self-adhesive tape over regions that were designed to be remained hydrophobic. Next, the masked film was placed in an RF plasma chamber (Model MPS-300; March Instruments, Inc., Concord, Calif., USA) and exposed to oxygen plasma at 30 W for 60 s while oxygen gas was flowing to the chamber. Then, the tape was removed before assembling the final device. In FIG. 22A, the arrow depicts the direction of wicking. Label number 550 indicates the edges of the transparent tape; 560 indicates oxygen plasma treated side and 570 indicates the side not receiving plasma treatment, with the demarcation between treated and untreated indicated by the dashed line. The microporous structures remained hydrophilic and wicked liquid even more than 90 days after oxygen plasma treatment (FIG. 22B). In FIG. 22B, label number 560 indicates oxygen plasma treated side and 570 indicates the side not receiving plasma treatment, with the demarcation between treated and untreated indicated by the dashed line.

### Example 5

### Micropore Interconnectivity Test

A liquid wicking test was used as a selection method for identify suitable microporous polymer films for use in the microfluidic devices. Specifically, the liquid wicking test is used to confirm the microporous structures that are patterned on polymer film surface are interconnected so that fluid (gas or liquid) can transport through the microporous structures. The test is performed by oxygen plasma treating the left half of the microporous surface of a patterned polymer film (e.g., a polystyrene film). The right half of the microporous surface is masked and protected by transparent self-adhesive tapes prior to oxygen plasma treatment. This retained the microporous surface's hydrophobicity. The tapes are removed after exposing the patterned film to the oxygen plasma treatment.

The wicking test is conducted by comparing the wetting behavior of the oxygen plasma treated (hydrophilic) and untreated (hydrophobic) sides of the patterned film. A transparent self-adhesive tape is adhered across the oxygen plasma treated (left side) and the untreated (right side) sides of the patterned film. The tape serves as a barrier to prevent the liquid from wicking over the top of the microporous structures. A droplet of red colored food dye is pipetted separately onto each side (FIG. 22A). The droplet placed on the untreated side shows very hydrophobic behavior by forming a near spherical droplet on the microporous surface. The droplet on the plasma treated side quickly wicks along the film by capillary action and travels underneath the tape and eventually emerges from the other end of the tape barrier. The tape forces the dye to wick through the body of the microporous structures and serves as a stringent test for the interconnectivity of the micropores. The dye stopped at the hydrophobic boundary where it is masked by transparent self-adhesive tape during the oxygen plasma treatment. The microporous structures remained hydrophilic and wicked liquid even more than 90 days after oxygen plasma treatment (FIG. 22B).

The wicking test demonstrates two important features of the THF/IPA solvent mixture patterned polystyrene film: first, the microporous structures are interconnected and second, that it is possible to custom pattern hydrophilic surfaces by simple transparent self-adhesive tape masking. The wicking property of the oxygen plasma treated microporous surface of the patterned polystyrene film (FIG. 22) can possibly be used to fabricate lateral flow biological assay microfluidic devices similar to recently reported paper-based analytical devices such as those described in Martinez et al., Analytical Chemistry, 2010, 82:3-10.

### Example 6

### pH Indicator Solution

Bromothymol blue solution (Fluka® Analytical; Sigma-Aldrich® Corporation, St. Louis, Mo., USA) was used as a pH indicator to track the absorption of carbon dioxide (CO₂) gas by water and the perfusion of acetic acid into water. The bromothymol blue pH indicator solution became blue at pH>7.6, green at pH˜6.5-7.0, and yellow at a pH<6.0. At the start of each experiment, the pH indicator solution with a pH of >7.6 (blue in color) was introduced into the outer circular channel of the microfluidic devices via a 1 ml syringe (NORM-JECT® Luer Slip Syringe; Air-Tite Products Co., Inc., Virginia Beach, Va., USA) and was left static.

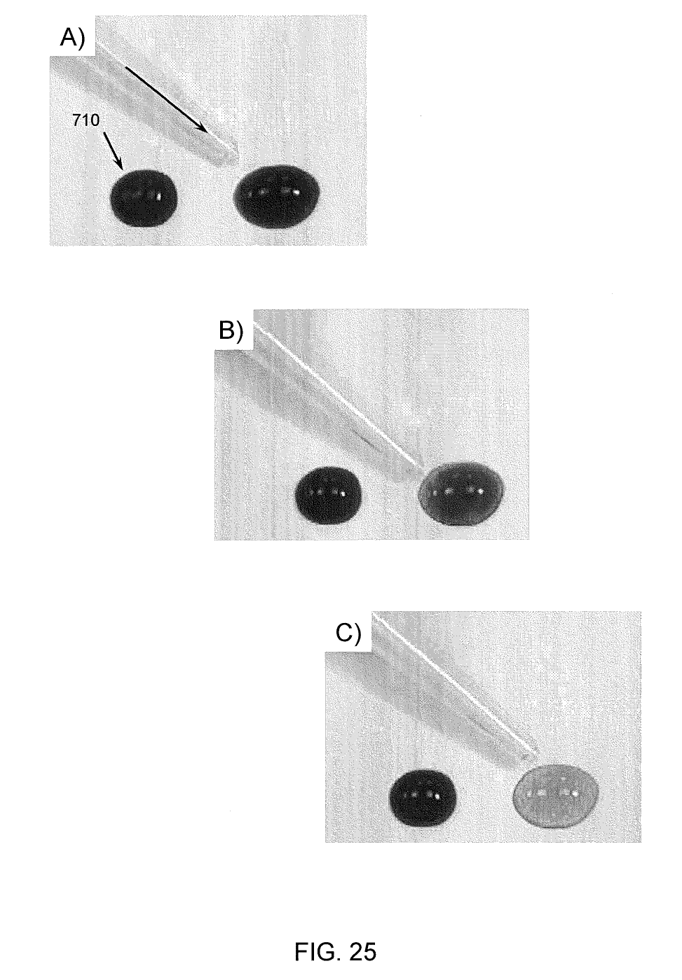

The results are shown in the time-lapsed images in FIG. 25A-C. In FIG. 25A, the label 710 indicates the control, and the arrow in the pipette indicates the flow of CO₂. FIGS. 25B-C show images as time passed.

### Example 7

### Acidification of Water by CO₂ Gas

Carbon dioxide gas was used in two sets of experiments to demonstrate gas permeability in the example microfluidic devices. In the first set of the experiments, CO₂ gas was generated inside a glass bubbler by dissolving dry ice in water. The generated CO₂ gas was directed from the bubbler through Tygon® tubing (Fisher Scientific, Pittsburgh, Pa., USA) into the inner circular chamber of the device without any other pumping means. In the second set of the experiments, CO₂ gas was generated within the device by mixing a saturated aqueous solution of sodium bicarbonate (NaHCO₃) (Fisher Scientific, Pittsburgh, Pa., USA) with household distilled white vinegar (5% acetic acid (CH₃COOH), Wegmans Food Markets, Inc., Rochester, N.Y., USA). Both solutions were introduced into the inner circular chamber of the device at a flow rate of 10 μl/min via a syringe pump (Model SP230IW; World Precision Instruments, Sarasota, Fla., USA). When the two solutions mixed, they generated CO₂ gas and became aqueous solution of sodium acetate (CH₃COONa) (Equation I). As water (H₂O) absorbed CO₂, it reacted with the CO₂ to form carbonic acid (H₂CO₃) (Equation II). Thus, the pH indicator solution would turn from blue to green to yellow depending on the amount of CO₂ was absorbed. (FIG. 25).

NaHCO₃(aq)+CH₃COOH(aq)→CO₂(g)+H₂O(l)+CH₃COONa(aq) (I)

H₂O(l)+CO₂(g) [symbol] H₂CO₃(aq) [symbol] H⁺+HCO₃⁻ (II)

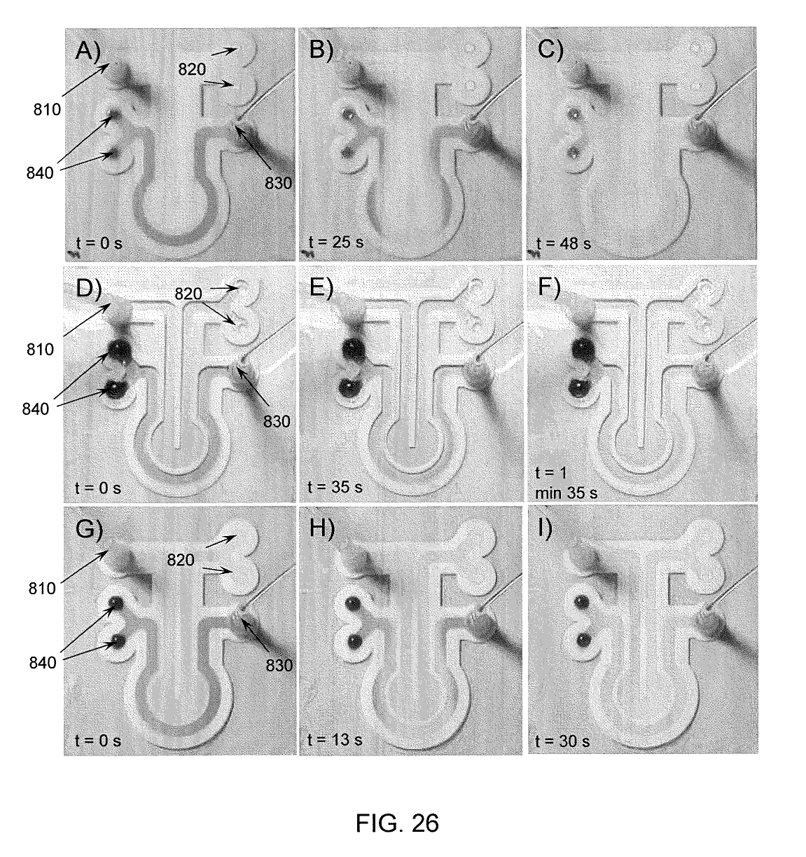

In the first set of gas experiments, after introducing the pH indicator solution with a pH of >7.6 (blue in color) into the outer circular channel of the microfluidic devices (FIGS. 26A, 26D and 26G), the pH indicator solution was clearly retained between the microporous channel side walls and the microporous structures remained dry during the experiments as indicated by their white appearance throughout the devices (FIG. 26). Next, CO₂ gas was delivered in and out of the inner circular chamber. This enabled CO₂ gas to gradually diffuse into the outer channel and prevented excess CO₂ gas from forcing the pH indicator solution out of the outer channel. The pH indicator solution gradually turned from blue to yellow during the experiments (FIG. 26). This indicated that CO₂ gas slowly diffused through the microporous structures and was being absorbed by the pH indicator solution. As expected, because of the high microporous surface area, the microfluidic device with both microporous bottom device surface and microporous channel side walls was the most efficient for the CO₂ gas to diffuse into the outer channel while the microfluidic device with the microporous channel side walls was the least efficient.

In FIG. 26, the labels 810 indicate the CO₂ gas inlet; 820 indicate the CO₂ gas outlet, 830 indicate the pH indicator solution inlet; 840 indicate the pH indicator solution outlet. The time that the image was taken is shown in the bottom left of each image with FIGS. 26A-C corresponding to one experiment, FIGS. 26D-F corresponding to another experiment, and FIGS. 26G-I corresponding to yet another experiment.

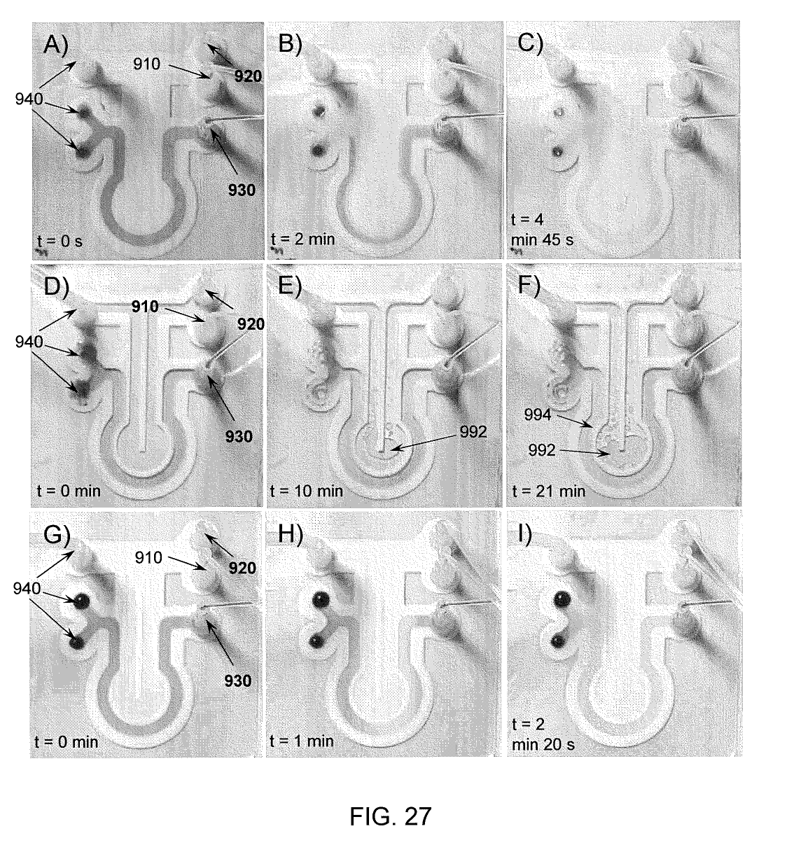

In the second set of gas experiments, CO₂ gas was generated inside the microfluidic devices and then used to acidify water within the same device. After we introduced the pH indicator solution with a pH of >7.6 (blue in color) into the outer circular channel of the microfluidic devices (FIGS. 27A, 27D, and 27G), saturated aqueous solution of sodium bicarbonate and household distilled white vinegar were continuously introduced into the inner circular chamber. The chemical reaction between sodium bicarbonate and vinegar generated CO₂ gas which could be seen as bubbles 992 inside the inner chamber and at the solution outlet (FIGS. 27E and 27F). The CO₂ gas diffused through the microporous structures and into the outer channel. As the CO₂ gas was absorbed by the pH indicator solution, the pH indicator solution gradually turned from blue to yellow (FIG. 27). The color change of the pH indicator solution was not caused by vinegar leaking through the hydrophobic untreated microporous structures. The untreated microporous structures repelled vinegar (FIG. 22B) and like the first set of gas experiments, the microporous structures remained dry during the experiments as indicated by their white appearance throughout the devices (FIG. 27). As described in the first set of gas experiments, because of the high microporous surface area, the microfluidic device with both microporous bottom device surface and microporous channel side walls was the most efficient for the CO₂ gas to diffuse into the outer channel while the microfluidic device with the microporous channel side walls was the least efficient.

In addition to the color change, it was also noticed that after a prolonged period of continuously generating CO₂ gas, bubbles 994 were formed inside the outer channel of the microfluidic device with the microporous channel side walls (FIG. 27F). This was the result of pressure gradually building up inside the inner chamber due to the continuation of CO₂ gas generation. Thus, CO₂ gas diffused through the microporous channel side wall between the inner chamber and the outer channel much faster than it could be absorbed by water. However, if desired, the amount of CO₂ gas generated as well as its pressure and diffusion rate inside the inner chamber can be controlled by adjusting the flow rates of the sodium bicarbonate solution and vinegar.

In FIG. 27, the labels 910 indicate the sodium bicarbonate inlet; 920 indicate the vinegar inlet; 930 indicate the pH indicator solution inlet; and 940 indicate the outlets. The time that the image was taken is shown in the bottom left of each image with FIGS. 27A-C corresponding to one experiment, FIGS. 27D-F corresponding to another experiment, and FIGS. 26G-I corresponding to yet another experiment.

### Example 8

### Acidification of Water by Acid

Acidification of water by acetic acid perfusion experiments were performed inside the microfluidic device by introducing distilled white vinegar into the inner circular chamber of the device at a flow rate of 5 μl/min via a syringe pump. The pH indicator solution inside the outer circular channel would turn from blue to yellow as vinegar perfused through the hydrophilic (oxygen plasma treated) microporous structures.

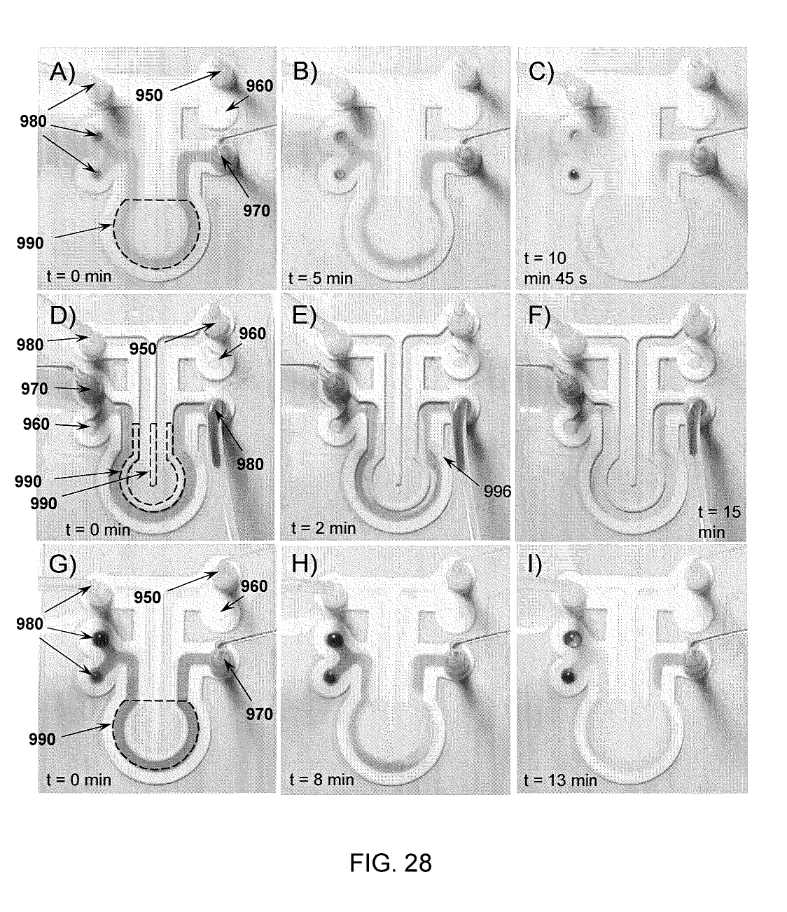

The same microfluidic device design used in the CO₂ gas generation and absorption experiments was used to demonstrate a liquid perfusion experiment. The difference in this experiment was that the microporous bottom device surface and the microporous channel side wall that separated the inner circular chamber and the outer circular channel were selectively oxygen plasma treated before assembling the final device (FIGS. 28A, 28D and 28G). The oxygen plasma treatment allowed liquid to wick through those treated (hydrophilic) microporous structures and perfuse between the inner chamber and the outer channel.

Same as the gas experiments, after the pH indicator solution with a pH of >7.6 (blue in color) was introduced into the outer channel and was left static (FIGS. 28A, 28D and 28G), distilled white vinegar was continuously introduced into the inner chamber. The pH indicator solution gradually changed from blue to yellow as vinegar gradually perfused into the outer channel (FIGS. 28B, 28E and 28H). The yellow color change initiated at the inner wall of the outer channel and diffused outward. Eventually, the whole outer channel turned yellow (FIGS. 28C, 28F and 28I). It was also noticed that the pH indicator solution which was perfused into the inner chamber from the outer channel at the start of the experiment was gradually being washed away by the vinegar which was introduced into the inner chamber (compared the inner chamber in FIG. 28A to FIG. 28C and FIG. 28G to FIG. 28I).

In FIG. 28, the labels 950 indicate the vinegar inlet; 960 indicate the blocked inlets; 970 indicate the pH indicator solution inlet; 980 indicates the outlets; and 990 indicates the oxygen plasma treated area, which is also indicated by the dashed lines. In FIG. 28E, 996 indicates an area where a mask imperfection resulted in unintended plasma treatment. The time that the image was taken is shown in the bottom left of each image with FIGS. 28A-C corresponding to one experiment, FIGS. 28D-F corresponding to another experiment, and FIGS. 28G-I corresponding to yet another experiment.

### Example 9

### Hansen Solubility Parameters for Solvents that Form Microporous Surfaces on Polystyrene Articles

As described in more detail in co-pending U.S. patent application Ser. No. 13/217,818, entitled MICROPOROUS THERMOPLASTIC SHEETS, having attorney docket no. SP11-197, naming Michael DeRosa, Todd Upton, and Ying Zhang as inventors, and filed on the same date herewith, we performed testing to determine which solvents or mixtures of solvents and non-solvents formed microporous surfaces on polystyrene articles and determined the Hansen RED values of those solvents and solvent/non-solvent mixtures that were effective in pore formation. A brief overview of those studies is presented herein.

Briefly, Hansen solubility parameters for solvent mixtures that form microporous surfaces on a molded polystyrene cell culture plate were determined in the following manner, which had a gradient of birefringence values across the surface (with a significant portion being greater than 0.001). First, a range of known solvents and non-solvents for polystyrene were tested on the surface of a molded polystyrene cell culture plate. 50-100 microliters of each test solvent and non-solvent were pipetted onto the surface of the polystyrene at room temperature. Observations were made under a microscope to see if the solvent dissolved the surface within a 2 min time period. Once a range of solvents and non-solvents were tested (see Table 1), the Hansen parameters, δP and δH, were plotted against each other for each test solvent. This type of two dimensional plot shows one cross section of the total three dimensional polystyrene solubility sphere.

TABLE 1

Solvents and non-solvents used to determine
Hansen Solubility Parameters

Solvents
1,1,1-Trichloroethane
Methylene Dichloride (Dichloromethane)
N-Methyl-2-Pyrrolidone
Ethyl Acetate
Dimethylformamide
n-Butyl Acetate
Chlorobenzene
Cyclohexanone
Isoamyl Acetate
1,3-Dioxolane
Toluene
Acetone
1,1-Dichloroethane
Tetrahydrofuran
Diethyl Ether
Methyl Ethyl Ketone
Non solvents
Cyclohexane
2-Propanol
Ethyl Lactate
Methanol
Dimethyl Sulfoxide
Glycerol
Water
Propylene Carbonate
1-Butanol
Ethanol

Using HSPiP software (Hansen Solubility Parameters in Practice, v.3.1) a fit of the data was calculated to determine the center coordinates of the polystyerene sphere and the solubility radius Rₒ. Data analysis using HSPiP software found the parameters to be δ_{D}=16.98, δ_{P}=6.76 and δ_{H}=4.83 with Rₒ=6.4. 50-100 micro liters of solvent/nonsolvent mixtures including tetrahydrofuran/water, tetrahydrofuran/isopropanol, tetrahydrofuran/propylene carbonate, ethylacetate/isopropanol, toluene/dimethyl sulfoxide, acetone/isopropanol, and 1,3 dioxolane/water were pipetted onto the polymer surface allowed to sit for 60 seconds then blow dried. The resulting surface features were observed under a microscope.

HSPiP software was used to determine the Hansen solubility parameters of the solvent/nonsolvent mixtures with the v/v % ranges shown in Table 2. The solubility parameters of the mixtures were plotted against the known solvent and non-solvent values determined earlier. A solubility boundary having a radius Rₒ=6.4 was determined. It was also found that the solubility parameter range of the solvent/non-solvent mixtures that formed microporous surfaces have RED values in the range of 0.88-1.41.

TABLE 2
Solvents with appropriate RED values to form microporous polystyrene

| Solvent/Non-solvent mixture | Range v/v% |
|---|---|
| Tetrahydrofuran/water | 50/50-65/35 |
| Tetrahydrofuran/isopropanol | 35/65-45/55 |
| Tetrahydrofuran/propylene carbonate | 37/63-50/50 |
| Ethylacetate/isopropanol | 60/40-70/30 |
| Toluene/dimethyl sulfoxide | 25/75-30/70 |
| Acetone/isopropanol | 70/30-80/20 |
| 1,3 Dioxolane/water | 60/40-80/20 |

While the polymeric articles tested in this example were molded cell culture articles, the Hansen solubility parameters should be representative of other polymeric articles.

Thus, embodiments of FLEXIBLE MICROFLUIDIC DEVICE WITH INTERCONNECTED POROUS NETWORK are disclosed. One skilled in the art will appreciate that the apparatuses and methods described herein can be practiced with embodiments other than those disclosed. The disclosed embodiments are presented for purposes of illustration and not limitation.

What is claimed is:

1. A method for fabricating a polymeric sheet having first and second channels separated by a sidewall having an interconnected porous network, comprising:
applying one or more masks to a surface of a polymeric sheet to produce a masked polymeric sheet, at least a portion of the one or more masks having a shape generally corresponding to the first and second channels;
contacting the masked polymeric sheet with a composition comprising a solvent to form the interconnected porous network from the unmasked portions of the polymeric sheet such that the interconnected porous network is raised relative to the masked surface of the polymeric sheet, wherein the composition has a Hansen relative energy difference from the polymer of the sheet of between 0.5 and 2;
removing the composition from the masked polymeric sheet;
removing the one or more masks from the masked polymeric sheet to expose the first and second channels, wherein the raised interconnected porous network between the first and second channels forms the sidewall separating the channels.

2. The method of claim 1, wherein the composition has Hansen relative energy difference from the polymer of between 0.75 and 1.6.

3. The method of claim 1, wherein the composition has Hansen relative energy difference from the polymer of between 0.8 and 1.5.

4. The method of claim 1, wherein the composition further comprises a non-solvent and wherein the ratio of solvent and non-solvent in the composition is between 30/70 and 99.9/0.01 by volume.

5. The method of claim 1, wherein the polymeric sheet is a polystyrene sheet and wherein the solvent comprises tetrahydrofuran or ethyl acetate and wherein the non-solvent comprises water, isopropanol or ethanol.

6. A method for fabricating a microfluidic device having first and second fluid conduits, comprising:
providing the polymeric sheet having first and second channels separated by a sidewall having an interconnected porous network produced according to claim 1;
applying a film to the polymeric sheet to form the microfluidic device, wherein the first conduit of the device comprises at least a portion of the film and the first channel of the polymeric sheet and wherein the second conduit of the device comprises at least a portion of the film and the second channel of the polymeric sheet.

7. The method of claim 6, wherein the polymeric sheet is a polystyrene sheet and wherein the solvent comprises tetrahydrofuran or ethyl acetate and wherein the non-solvent comprises water, isopropanol or ethanol.

8. The method of claim 6, wherein the film is adhesive tape.

9. The method of claim 6, wherein the film is a polymeric sheet having an interconnected porous network.

10. The method of claim 9, wherein the film is a polymeric sheet having a patterned interconnected porous network.

11. The method of claim 6, further comprising:
creating openings in a double-sided adhesive sheet having widths, lengths and shapes substantially the same as the first and second channels of the polymeric sheet;
applying the double-sided adhesive sheet to the polymeric sheet such that the openings in the double-sided adhesive sheet are substantially aligned with the first and second channels of the polymeric sheet,
wherein applying the film to the polymeric sheet comprises applying the film to the side of the double-sided adhesive that is not adhered to the polymeric sheet.

12. The method of claim 6, further comprising increasing the hydrophilicity of at least a portion of the interconnected porous network between the first and second channels to allow aqueous fluid to flow between the first and second channels through the porous sidewall.

13. The method of claim 12, wherein increasing the hydrophilicity of the at least a portion of the interconnected porous network comprises plasma treating at least a portion of the interconnected porous network.

14. A method for fabricating a polystyrene sheet having an interconnected porous network, comprising:
contacting at least a portion of the polystyrene sheet with a composition comprising a solvent, wherein the composition has a Hansen relative energy difference from the polymer of the sheet of between 0.5 and 2.

15. The method of claim 14, wherein the composition has Hansen relative energy difference from the polymer of between 0.75 and 1.6.

16. The method of claim 14, wherein the composition further comprises a non-solvent, wherein the solvent is tetrahydrofuran or ethyl acetate and wherein the non-solvent is an alcohol selected from isopropanol and ethanol, wherein, if tetrahydrofuran is the solvent, the ratio of tetrohydrofuran to alcohol is between 30/70 and 45/55 by volume and wherein, if ethyl acetate is the solvent, the ratio of ethyl acetate to alcohol is between 44/55 and 65/35 by volume.

17. A method for fabricating a microfluidic device, comprising:
providing a polystyrene sheet having an interconnected porous network fabricated according to the method of claim 14,
applying a patterned double-sided adhesive sheet to the polystyrene sheet, wherein the adhesive sheet is patterned to include a first opening configured to form at least a portion of a first fluid conduit of the microfluidic device; and
applying a film to the other side of the adhesive sheet.

18. A method for fabricating a microfluidic device, comprising:
providing a polystyrene sheet having an interconnected porous network fabricated according to the method of claim 14, wherein the polystyrene sheet includes a channel formed by masking the sheet prior to contacting with the composition comprising solvent and non-solvent; and
applying a film to polystyrene sheet to cover the channel and form a fluid conduit.

19. A microfluidic device comprising:
a polymeric sheet having first and second channels separated by a sidewall having an interconnected porous network;
a film; and
a patterned double-sided adhesive sheet disposed between the film and the polymeric sheet, the patterned double-sided adhesive sheet having openings with widths, lengths, and shapes substantially the same as the first and second channels of the polymeric sheet, wherein the openings of the patterned double-sided adhesive sheet are aligned with the first and second channels of the polymeric sheet.

20. The microfluidic device of claim 19, wherein the polymeric sheet is a polystyrene sheet.
